(19) United States
(12) Patent Application Publication
(10) Pub. No.: US 2026/0044253 A1
(43) Pub. Date: Feb. 12, 2026

(54) DYNAMICALLY GENERATING USER INTERFACE COMPONENTS

(71) Applicant: Google LLC, Mountain View, CA (US)

(72) Inventors: Syeda Saba Zehra Zaidi, Mountain View, CA (US); Zaheed Md Shahjahan Sabur, Baar (CH); Tracy Elizabeth Barmore, Austin, TX (US); Matthew C. Stokes, Hancock, NH (US); Simon Edward Roberts, London (GB); Charmaine Cynthia Rose D'Silva, Campbell, CA (US); Oliver Thomas Gaymond, London (GB); Zhipeng Pan, San Francisco, CA (US); Carsten Hinz, Mountain View, CA (US); Simon Charles Tickner, London (GB); Ankur Badola, Karnataka (IN); Bhavana Motwani, Karnataka (IN); Danyi Wang Robertson, Mountain View, CA (US); John Gruen, Mountain View, CA (US); Kinda Akash, Oakland, CA (US); Peter Scott Hershey, San Francisco, CA (US); Sneha Virmani, London (GB); Leslie Kunling Wang, Mountain View, CA (US); Hanna Yoon, Mountain View, CA (US)

(21) Appl. No.: 19/295,265

(22) Filed: Aug. 8, 2025

Related U.S. Application Data
(60) Provisional application No. 63/682,166, filed on Aug. 12, 2024.

(51) Int. Cl. G06F 3/0484; G10L 15/26

(52) U.S. Cl. CPC G06F 3/0484; G10L 15/26

(57) ABSTRACT

An example computing system receives an indication of an input detected at a location of an input device that corresponds to a graphical component from a first plurality of graphical components. The computing system retrieves information associated with at least a portion of content included in a current graphical user interface, and determines, based on one or more of the information associated with at least the portion of the content and the indication of the input, at least one prompt. The computing system determines, by applying the machine learning model to the at least one prompt and at least the portion of the content, one or more suggested outputs. The computing system generates instructions for generating a second plurality of graphical components, in which the second plurality of graphical components is associated with the one or more suggested outputs.

This application claims priority to U.S. Provisional Patent Application No. 63/682,166, entitled “DYNAMICALLY GENERATING USER INTERFACE COMPONENTS,” filed Aug. 12, 2024, which is incorporated by reference in its entirety herein.

### BACKGROUND

Applications executed on computing devices may present a wide variety of content to users, such as text, images, videos, interactive user interface elements, etc. However, navigating through this content, and to other applications based on the content, may be time-consuming, frustrating, or overwhelming for users, especially when a user has a simple query or intent pertaining to the content. Furthermore, users may find it difficult to determine relevant actions, tasks, and applications when the content includes large amounts of unorganized information.

### SUMMARY

In general, techniques of this disclosure are directed to techniques for applying a large language model to received input and content of a current application graphical user interface in order to dynamically generate graphical components that correspond to suggested output. A remote computing device (e.g., a smartphone) may execute an application, in which a current graphical user interface (GUI) of the application includes a variety of content (e.g., text, images, videos, interactive graphical components, etc.). A computing system may retrieve information indicative of at least a portion of the content (e.g., content included in a current frame of a scrollable GUI, all content included in the entire scrollable GUI, etc.), which may be responsive to receiving an indication of an input (e.g., a tactile event, natural language text, and/or natural language speech) detected at a location of an input device corresponding to a graphical component (e.g., a button). For example, while viewing a website page that includes a video for home decorating, a user may interact with a widget including a microphone button and provide a natural language input such as, “Where can I buy the pillows in this video?” In some examples, the computing system may determine, based on the input, at least one prompt (e.g., a query, command, etc.), such as the explicitly stated prompt, “Where can I buy the pillows in this video?” In another example, a current frame of a messaging application GUI may include a text message such as, “I've been meaning to try that restaurant on 1st Ave. Also, Jenny and Mike will be in town too. How does 7 PM sound?” The computing system may retrieve the content information of the current frame, such as the text message, and apply a machine learning model (e.g., a large language model) to the content information to determine at least one prompt, such as an implicitly stated prompt, “Book a reservation at the restaurant on 1st Ave for 4 people at 7 PM.” In some examples, the computing system may apply the machine learning model to the prompt and the retrieved content information to determine at least one suggested output. In some examples, the at least one suggested output includes at least one associated application, text, at least one image, at least one link, or the prompt itself (e.g., as a suggested action). The computing system may generate instructions for dynamically generating graphical components associated with the at least one suggested output (e.g., an expandable widget that displays text, a widget for a suggested action, a widget for a suggested application, etc. For example, a suggested output based on the video for home decorating and the “Where can I buy the pillows in this video?” prompt may be text output such as, “Here are the places where you can buy these pillows in the video: First two pillows from Store A, third lumbar pillow from Store B.” The text output may be displayed in an expanded widget that overlays the video page GUI, and in some examples, may include embedded links, such as links to website pages for Store A and Store B. As another example, based on the example text message above and the determined prompt, “Book reservation at restaurant on 1st Ave for 4 people at 7 PM,” the suggested output may be prepopulated in text entry fields included in a GUI for a suggested restaurant reservations application, which may be presented as a widget that is dynamically rendered when a user hovers over the text message.

In one example, the disclosure is directed toward a method that includes receiving, by a computing system, an indication of an input detected at a location of an input device that corresponds to a graphical component from a first plurality of graphical components, and retrieving, by the computing system, information associated with at least a portion of content included in a current graphical user interface. The method further includes determining, by the computing system, and based on one or more of the information associated with at least the portion of the content and the indication of the input, at least one prompt. The method further includes determining, by the computing system, and by applying the machine learning model to the at least one prompt and at least the portion of the content, one or more suggested outputs. The method further includes generating, by the computing system, instructions for generating a second plurality of graphical components, wherein the second plurality of graphical components is associated with the one or more suggested outputs.

In another example, the disclosure is directed toward a computing system comprising one or more processors, and one or more storage devices that store instructions. The instructions, when executed by the one or more processors, cause the one or more processors to receive an indication of an input detected at a location of an input device that corresponds to a graphical component from a first plurality of graphical components. The instructions further cause the one or more processors to retrieve information associated with at least a portion of content included in a current graphical user interface, and determine, based on one or more of the information associated with at least the portion of the content and the indication of the input, at least one prompt. The instructions further cause the one or more processors to determine, by applying the machine learning model to the at least one prompt and at least the portion of the content, one or more suggested outputs. The instructions further cause the one or more processors to generate instructions for generating a second plurality of graphical components, wherein the second plurality of graphical components is associated with the one or more suggested outputs.

In another example, the disclosure is directed toward a non-transitory computer-readable storage medium encoded with instructions that, when executed by one or more processors, cause one or more processors to receive an indication of an input detected at a location of an input device that corresponds to a graphical component from a first plurality of graphical components. The instructions further cause the one or more processors to retrieve information associated with at least a portion of content included in a current graphical user interface, and determine, based on one or more of the information associated with at least the portion of the content and the indication of the input, at least one prompt. The instructions further cause the one or more processors to determine, by applying the machine learning model to the at least one prompt and at least the portion of the content, one or more suggested outputs. The instructions further cause the one or more processors to generate instructions for generating a second plurality of graphical components, wherein the second plurality of graphical components is associated with the one or more suggested outputs.

In another example, the disclosure is directed toward a computer program product for generating graphical components that correspond to suggested output. The computer program product comprises one or more instructions that, when executed by at least one processor, cause the at least one processor to receive an indication of an input detected at a location of an input device that corresponds to a graphical component from a first plurality of graphical components. The one or more instructions further cause the at least one processor to retrieve information associated with at least a portion of content included in a current graphical user interface, and determine, based on one or more of the information associated with at least the portion of the content and the indication of the input, at least one prompt. The one or more instructions further cause the at least one processor to determine, by applying the machine learning model to the at least one prompt and at least the portion of the content, one or more suggested outputs. The one or more instructions further cause the at least one processor to generate instructions for generating a second plurality of graphical components, wherein the second plurality of graphical components is associated with the one or more suggested outputs.

The details of one or more examples of the disclosure are set forth in the accompanying drawings and the description below. Other features, objects, and advantages of the disclosure will be apparent from the description and drawings, and from the claims.

### BRIEF DESCRIPTION OF THE FIGURES

FIGS. 1A-1B are conceptual diagrams illustrating an example computing system for receiving input and content of a current application graphical user interface to dynamically generate suggested output and corresponding graphical components, in accordance with one or more techniques of this disclosure.

FIG. 2 is a conceptual diagram illustrating another example computing system for receiving input and content of a current application graphical user interface to dynamically generate suggested output and corresponding graphical components, in accordance with one or more techniques of this disclosure.

FIG. 3 is a block diagram illustrating another example computing system configured to apply a machine learning module to input and content of a current application graphical user interface to dynamically generate suggested output and corresponding graphical components, in accordance with one or more techniques of this disclosure.

FIG. 4 is a conceptual diagram illustrating a machine learning module configured to apply a large language model that accepts natural language input and provides suggested output and code for corresponding graphical components, in accordance with one or more techniques of this disclosure.

FIGS. 5A-5C are conceptual diagrams illustrating another example computing system for sending suggested output and corresponding graphical components based on at least one prompt, in accordance with one or more techniques of this disclosure.

FIG. 6 is a conceptual diagram illustrating another example computing system for sending suggested output and corresponding graphical components based on at least one prompt, in accordance with one or more techniques of this disclosure.

FIG. 7A is a conceptual diagram illustrating another example computing system for sending suggested output and corresponding graphical components based on at least one prompt, in accordance with one or more techniques of this disclosure.

FIG. 7B is another example of the computing system of FIG. 7A for sending suggested output and corresponding graphical components based on at least one prompt, in accordance with one or more techniques of this disclosure.

FIG. 7C is another example of the computing system of FIG. 7A for sending suggested output and corresponding graphical components based on at least one prompt, in accordance with one or more techniques of this disclosure.

FIG. 8 is a flowchart illustrating an example operation for sending suggested output and corresponding graphical components based on at least one prompt, in accordance with one or more techniques of this disclosure.

### DETAILED DESCRIPTION

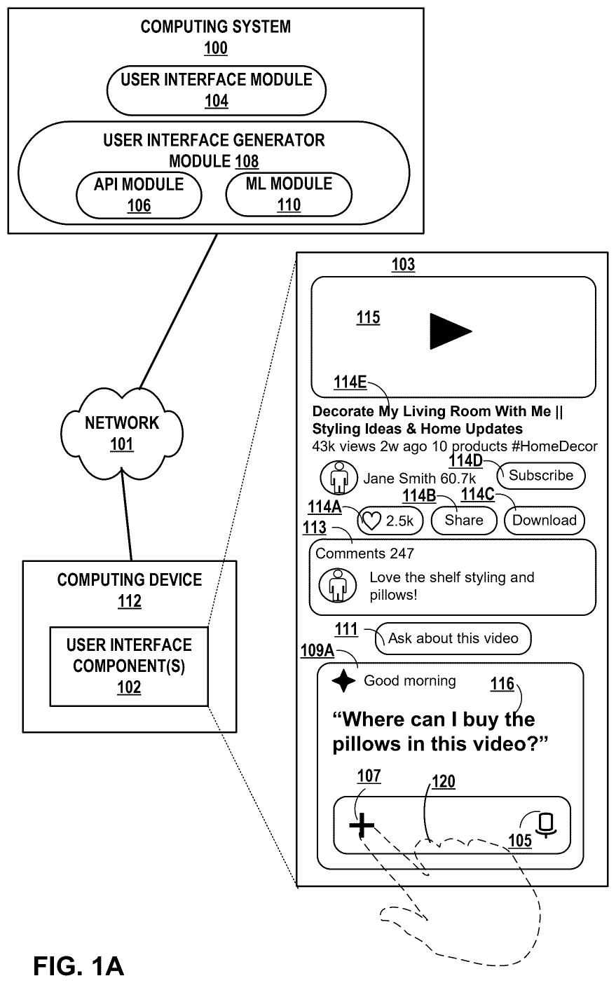

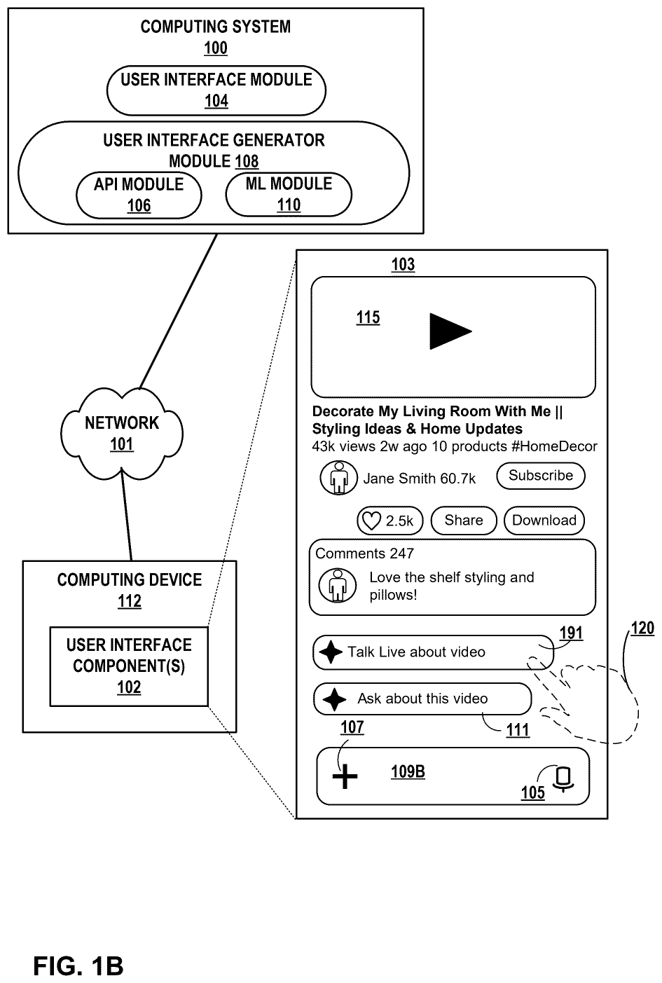

FIGS. 1A-1B are conceptual diagrams illustrating an example computing system for receiving input and content of a current application graphical user interface to dynamically generate suggested output and corresponding graphical components, in accordance with one or more techniques of this disclosure. In the example of FIG. 1A, a user 120 interacts with computing device 112 that is in communication with computing system 100. In some examples, some or all of the components and/or functionality attributed to computing system 100 may be implemented or performed by computing device 112.

While not explicitly shown in the example of FIG. 1A, computing system 100 may be implemented on a plurality of computing devices that may include, but are not limited to, portable, mobile, or other devices, such as mobile phones (including smartphones), laptop computers, desktop computers, tablet computers, smart television platforms, server computers, mainframes, etc. In some examples, computing system 100 may represent a cloud computing system that provides one or more services via network 101. That is, in some examples, computing system 100 may be a distributed computing system.

Computing system 100 may communicate with computing device 112 via network 101. Network 101 may include any public or private communication network, such as a cellular network, Wi-Fi network, a direct cell-to-satellite communication network, or other type of network for transmitting data between computing system 100 and computing device 112. In some examples, network 101 may represent one or more packet switched networks, such as the Internet. Computing device 112 may send and receive data to and from computing system 100 across network 101 using any suitable communication techniques. For example, computing system 100 and computing device 112 may each be operatively coupled to network 101 using respective network links. Network 101 may include network hubs, network switches, network routers, etc., that are operatively inter-coupled thereby providing for the exchange of information between computing device 112 and computing system 100. In some examples, network links of network 101 may be Ethernet, ATM or other network connections. Such connections may include wireless and/or wired connections.

As shown in the example of FIG. 1A, computing device 112 includes one or more user interface (UI) components (“UI components 102”). UI components 102 of computing device 112 may be configured to function as input devices and/or output devices for computing device 112. UI components 102 may be implemented using various technologies. For instance, UI components 102 may be configured to receive input from user 120 through tactile, audio, and/or video feedback. Examples of input devices include a presence-sensitive display, a presence-sensitive or touch-sensitive input device (such as that shown in FIG. 1A), a mouse, a keyboard, a voice responsive system, video camera, microphone or any other type of device for detecting a command from user 120. In some examples, a presence-sensitive display includes a touch-sensitive or presence-sensitive input screen, such as a resistive touchscreen, a surface acoustic wave touchscreen, a capacitive touchscreen, a projective capacitive touchscreen, a pressure sensitive screen, an acoustic pulse recognition touch screen, or another presence-sensitive technology. That is, UI components 102 of computing device 112 may include a presence-sensitive device that may receive tactile input from user 120. UI components 102 may receive indications of the tactile input by detecting one or more gestures from user 120 (e.g., when user 120 touches or points to one or more locations of UI components 102 with a finger or a stylus pen).

UI components 102 may additionally or alternatively be configured to function as an output device by providing output to user 120 using tactile, audio, or video stimuli. Examples of output devices include a sound card, a video graphics adapter card, or any of one or more display devices, such as a liquid crystal display (LCD), dot matrix display, light emitting diode (LED) display, microLED, miniLED, organic light-emitting diode (OLED) display, e-ink, or similar monochrome or color display capable of outputting visible information to user 120. Additional examples of an output device include a speaker, a haptic device, or other device that can generate intelligible output to a user. For instance, UI components 102 may present output to user 120 as a graphical user interface that may be associated with functionality provided by computing device 112. In this way, UI components 102 may present various user interfaces of applications executing at or accessible by computing device 112 (e.g., an electronic message application, an Internet browser application, etc.). User 120 may interact with a respective user interface of an application to cause computing device 112 to perform operations relating to a function provided by the application.

In some examples, UI components 102 of computing device 112 may detect two-dimensional and/or three-dimensional gestures as input from user 120. For instance, a sensor of UI components 102 may detect the user's movement (e.g., moving a hand, an arm, a pen, a stylus, etc.) within a threshold distance of the sensor of UI components 102. UI components 102 may determine a two- or three-dimensional vector representation of the movement and correlate the vector representation to a gesture input (e.g., a hand-wave, a pinch, a clap, a pen stroke, etc.) that has multiple dimensions. In other words, UI components 102 may, in some examples, detect a multidimensional gesture without requiring the user to gesture at or near a screen or surface at which UI components 102 output information for display. Instead, UI components 102 may detect a multi-dimensional gesture performed at or near a sensor which may or may not be located near the screen or surface at which UI components 102 output information for display.

In the example of FIG. 1A, computing system 100 includes user interface (UI) module 104. Module 104 may perform operations described herein using hardware, software, firmware, or a mixture thereof residing in and/or executing at computing system 100. Computing system 100 may execute module 104 with one processor or with multiple processors. In some examples, computing system 100 may execute module 104 as a virtual machine executing on underlying hardware. Module 104 may execute as one or more services of an operating system or computing platform or may execute as one or more executable programs at an application layer of a computing platform.

UI module 104, as shown in the example of FIG. 1A, may be operable by computing system 100 to perform one or more functions, such as receive input and send indications of such input to other components associated with computing system 100. UI module 104 may also receive data from components associated with computing system 100. Using the data received, UI module 104 may cause other components associated with computing system 100, such as UI components 102, to provide output based on the data. For instance, UI module 104 may send data to UI components 102 of computing device 112 to display a GUI, such as GUI 103.

In general, user 120 may be provided with an opportunity to provide input to control whether programs or features of computing device 112 and/or computing system 100 can collect and make use of user information (e.g., user 120's personal data, information about user 114's current location, location history, activity, etc.), or to dictate whether and/or how computing device 112 and/or computing system 100 may receive content that may be relevant to user 120. Other user information may include data that includes the context of user usage, either obtained from an application itself or from other sources. Examples of usage context may include breadth of share (sharing publicly, or with a large group, or privately, or a specific person), context of share, etc. When permitted by the user, additional data can include the state of the device, e.g., the location of the device, the apps running on the device, etc. In addition, certain data may be treated in one or more ways before it is stored or used by computing device 112 and/or computing system 100 so that personally identifiable information is removed. For example, a user's identity may be treated so that no personally identifiable information can be determined about the user, or a user's geographic location may be generalized where location information is obtained (such as to a city, ZIP code, or state level), so that a particular location of a user cannot be determined. Thus, user 120 may have control over how information is collected about them and used by computing device 112 and/or computing system 100. For example, user 120 may be prompted by computing device 112 to provide explicit consent for computing device 112 and/or computing system 100 to retrieve and/or store any or all of user 120's data. In some examples, an action log executed on computing device 112 may provide user 120 a ledger of activity, which may show any automations or applications running in the background of computing device 112, as well as an accurate log of all UI generator module 108 activity.

In the example of FIG. 1A, graphical user interface (GUI) 103 may be an example representation of a current GUI of an application executed by computing device 112. For example, as shown, GUI 103 may be a current GUI of a video platform application. In some examples, GUI 103 may be scrollable. In some examples, GUI 103 may include a plurality of user interface elements, some of which may be considered “widgets.” In some examples, GUI 103 includes one or more user interface elements that correspond to content hosted by the application. For example, as shown in FIG. 1A, GUI 103 includes video player 115, user interface elements 114A-114E, comments section 113, suggested input 111, and widget 109A, which may include button 107, microphone button 105, and a text entry field for natural language input 116 (which, as shown, may be a natural language query such as, e.g., “Where can I buy the pillows in this video?”). A widget may be a smaller GUI or GUI element that provides specific functionality or access to a larger application. For example, widget 109A may represent an application or functionality provided by computing system 100 that can apply a large language model to received input, such as the natural language input (e.g., a query such as “Where can I buy the pillows in this video?”) and content of GUI 103 in order to dynamically generate graphical components that correspond to suggested output. In general, widget 109A may be a “floating” user interface element (e.g., an overlay). In general, widget 109A may be included in a bottom portion of a current screen of computing device 112 and may persist across multiple applications and/or GUIs.

More specifically, in some examples, computing system 100 may receive an indication of an input detected at a location of an UI component 102 that corresponds to a graphical component from a first plurality of graphical components. For example, user 120 may interact with button 107 to manually type natural language input 116. In another example, user 120 may interact with microphone button 105 to provide natural language input 116 through a “touch and talk” feature. For example, in the example of the touch and talk feature, user 120 may hold down on and/or tap microphone button 105 with their finger, and provide natural language input 116 such as, “Where can I buy the pillows in this video?” in which holding down on and/or tapping microphone button 105 may be a gesture that causes a user interface component 102 (e.g., a microphone) of computing device 112 to capture natural language input 116.

In the example of FIG. 1A, video player 115 may be a user interface component that plays video content hosted on the video platform application. User interface elements 114A-114E may each correspond to various functionality or other content included in the video platform application. For example, button 114A may be a “like” or “favorite” button, button 114B may be a “share” button (which may provide functionality for sharing the video played by video player 115), 114C may be a “download” button (which may provide functionality for downloading the video played by video player 115), and 114E may be descriptive text related to the video played by video player 115 (e.g., a title of the video such as “Decorate My Living Room With Me | Styling Ideas & Home Updates”). Comments sections 113 may include comments posted by users of the video platform (e.g., as shown, a user may post a comment such as, “Love the shelf styling and pillows!”). The content included in GUI 103 of FIG. 1A may be just one example of content included in an example application executing on computing device 112. That is, the techniques described herein may be applied to various types of content (text, images, videos, user interface elements, etc.) hosted on various types of applications (e.g., video playback applications, entertainment applications, messaging applications, social media applications, document viewer and/or editor applications, health applications, shopping applications, banking applications, etc.).

In accordance with techniques of this disclosure, computing system 100 may include a user interface generator module 108 that applies a large language model to input, such as natural language input, and/or content of a current GUI, in order to dynamically generate graphical components that correspond to suggested output. Specifically, with explicit consent from user 120, user interface generator module 108 may retrieve, via API module 106, information associated with at least a portion of content included in a current graphical user interface.

In general, with explicit consent from user 120, user interface generator module 108 may run continuously and be configured to monitor the content of one or more applications and/or user activity. In an example involving one or more applications executing on computing device 112, with explicit consent from user 120, user interface generator module 108 may run continuously in the background of computing device 112 and be configured to monitor the content of one or more applications executing at computing device 112 and/or user activity within computing device 112. In other words, API 106 receives explicit consent from user 120 to gather information from user 120 and one or more applications executing on computing device 112 operated by user 120. In general, user interface generator module 108 may receive an indication of a natural language user input 116 associated with the content included in the current GUI, again provided that user 120 has given explicit permission for computing system 100 to monitor/receive user 120's data.

In some examples, API module 106 may provide information about user interface elements, events, and actions to assistive technologies (e.g., screen readers, magnification gestures, switch devices, etc.) provided by computing system 100 or computing device 112. In some examples, API module 106 may be configured to enable the exchanging of data in a standardized format. For example, API module 106 may support REST (Representational State Transfer), which is a widely-used architectural style for building APIs that use HTTP (Hypertext Transfer Protocol) to exchange data between applications.

In some examples, API module 106 may be configured to generate a stream of accessibility events as the user interacts with computing device 112 and applications executed on computing device 112. In some examples, these events may represent actions and changes in a user interface, such as button presses, text changes, and screen transitions. With explicit consent from user 120, user interface generator module 108 may receive and analyze these events to better understand how user 120 interacts with an application executing on computing device 112.

API module 106 may be configured to retrieve accessibility actions from applications executed on computing device 112. “Accessibility actions” may refer to different types of inputs that can be detected at a location associated with a UI component 102, such as mechanical inputs (e.g., a clicking of a button, a swiping of a screen, etc.), audio input (e.g., verbal command), or gesture control (e.g., triple tapping on a screen, hand wave, assistive gestures, etc.). As such, accessibility actions may provide users the ability to interact with an application or user interface element in multiple ways according to their needs. In some examples, with explicit consent from user 120, computing system 100 may determine which accessibility actions are frequently performed by user 120 when interacting with a GUI or application such that the new user interface generated by user interface generator module 108 can be better tailored for user 120's needs. In some examples, the information retrieved by API module 106 from computing device 112 may be stored by computing system 100 to identify potential accessibility issues and/or better understand how user 120 interacts with computing device 112. In some examples, user interface generator module 108 may use information retrieved from computing device 112 to determine the format, size, color scheme, accessibility features, or any other features to include in the suggested output and/or corresponding graphical components. In some examples, user interface generator module 108 may also provide users the ability to configure various accessibility and/or display options according to their needs. For example, user 120 may be able to adjust the user interface elements of a GUI or widget, such as text size, enable color correction, set up magnification gestures, and configure gesture-based navigation.

In general, user interface generator module 108 may send information (e.g., location information, other contextual information, etc.) to machine learning module 110 only if computing system 100 receives permission from the user of computing device 112 to send the information. For example, in situations discussed here in which computing system 100 and/or computing device 112 may collect, transmit, or may make use of personal information about a user (e.g., location information, financial information, etc.), the user may be provided with an opportunity to control whether programs or features of computing system 100 can collect user information (e.g., information about a user's social network, a user's social actions or activities, a user's profession, a user's preferences, or a user's current location), or to control whether and/or how computing system 100 and/or computing device 112 may store and share user information. In addition, certain data may be treated in one or more ways before it is stored, transmitted, or used so that personally identifiable information is removed. For example, a user's identity may be treated so that no personally identifiable information can be determined about the user. Thus, the user may have control over how information is collected about the user and stored, transmitted, and/or used in accordance with techniques of this disclosure.

In general, user interface generator module 108 may receive, from computing device 112, and provided that user 120 has given explicit consent, an indication of a natural language user input 116 (e.g., audio or text input from user 120) associated with the content of GUI 103. In other words, the indication of a natural language user input may represent user 120's command or intent. In some examples, natural language user input 116 may represent user 120's commands and/or desires for performing one or more tasks. In some examples, user 120 may provide natural language input that represents any number of prompts, commands, intents, tasks, queries, and the like. That is, user 120 may say aloud any number of intents in a single utterance, which may include intents pertaining to different types of content included in a current GUI.

In general, API module 106 may be configured to retrieve various types of data from GUI 103 and/or the application associated with GUI 103 (e.g., source code, data, information, etc.), which user interface generator module 108 may interpret in order to understand the content and/or functionalities provided by GUI 103 and/or the associated application. User interface generator module 108 may further use the retrieved information to contextualize the indication of natural language user input 116 when applying machine learning module 110. As one example, responsive to user 120 provide the natural language user input such as “Where I can buy the pillows in this video?”, user interface generator module 108 may retrieve, with explicit consent from user 120, data from GUI 103 and/or the associated application, such as the video content played by video player 115.

As such, computing system 100 may retrieve information indicative of at least a portion of the content (e.g., all content included in GUI 103), which may be responsive to receiving an indication of an input (e.g., a tactile event, natural language text, and/or natural language speech) detected at a location of an input device corresponding to a graphical component (e.g., user 120 interacting with microphone button 105 of widget 109A to provide natural language input 116 through the “touch and talk” feature). In some examples, widget 109A may be presented as an overlay along with an overlay for suggested input 111, which may be, for example, a suggested action for user 120 to provide as input, such as “Ask about this video.” In the example of FIG. 1A, GUI 103 may be a GUI for a website page or video platform that hosts the video played by video player 115, which may be a video for home decorating. As such, computing system 100 may retrieve information indicative of the video (e.g., via API module 106, scraping, etc.) for home decorating (e.g., video data, such as transcript data, contextual data, video metadata, etc.) responsive to user 120 interacting with the widget for suggested input 111 and/or providing natural language input 116.

In some examples, computing system 100 may determine, based on natural language input 116, at least one prompt (e.g., a query, command, etc.), such as the explicitly stated prompt, “Where can I buy the pillows in this video?”. In some examples, computing system 100 may apply machine learning model 110 to the prompt and the retrieved content information to determine at least one suggested output. That is, computing system 100 may apply machine learning model 110 to the prompt and the retrieved content information to determine answer a user's query, perform a user's command, generate desired output, etc. In general, machine learning module 110 may represent an artificial intelligence (AI) system or agent that utilizes various machine learning models, rules, and data processing techniques to generate output. In some examples, the at least one suggested output includes at least one associated application, text, at least one image, at least one link, or the prompt itself (e.g., as a suggested action). As an example, based on the prompt, “Where I can buy the pillows in this video?”, and the retrieved content information from GUI 103, UI generator module 108 of computing system 100 may determine a suggested output that “answers” the prompt, e.g., UI generator module 108 may determine a suggested output such as, “Here are the places where you can buy these pillows in the video: First two pillows from Store A, third lumbar pillow from Store B.” More specifically, computing system 100 may generate instructions for dynamically generating graphical components associated with the at least one suggested output (e.g., an expandable widget that displays text, a widget for a suggested action, a widget for a suggested application, etc.). In some examples, the output may include embedded links, such as links to website pages for, e.g., Store A and Store B. In some examples, the text output may be displayed in widget 109A, which may be an expandable widget that overlays GUI 103. In some examples, user 120 may swipe their finger in an upwards motion over widget 109A, which may cause widget 109A to expand into a full screen GUI for an application associated with widget 109A.

FIG. 1B illustrates another example of GUI 103, which may be overlaid with widget 109B (which may be a minimized version of widget 109A of FIG. 1A), but may be overlaid with another widget for suggested input, e.g., widget 191 with suggested input “Talk Live about video.” In some examples, a suggested input may be based on the type of application currently being executed and/or the content currently being presented on a user's screen. That is, in some examples, computing system 100 may generate suggested inputs based on application functionality and/or capabilities. In the example of FIG. 1B, responsive to user 120 interacting with widget 191, computing system 100 may implement machine learning module 110 (which may represent an AI system or agent) to receive user queries and generate responses to the user queries, e.g., in a conversational format. That is, in some examples, machine learning module 110 may act as an AI system or agent that may participate in free-flowing, voice-based conversations with user 120, thereby providing real-time or near real-time assistance to user 120.

In the example of FIG. 1B, responsive to user 120 interacting with widget 191, widget 109B may be expanded to include text indicative of a conversation between user 120 and machine learning module 110. In some examples, responsive to user 120 interacting with widget 191, another application may be executed by computing device 112 and/or another GUI may be presented to user 120, in which the application and/or GUI may be used to facilitate the conversation between user 120 and machine learning module 110. Furthermore, in some examples, responsive to user 120 interacting with widget 191, the video played by video player 115 may be provided as input to machine learning module 110 and/or may be uploaded as input to the application.

In general, audio may be output to user 120 via UI components 102 (e.g., a speaker), in which the audio may be indicative of output generated by machine learning module 110. For instance, based on the suggested prompt, “Talk Live about video,” machine learning module 110 may initiate a conversation with user 120 about the video played by video player 115.

More specifically, machine learning module 110 may continually harvest context information from input provided by user 120 (e.g., natural language speech), current screen information, content included in the current screen, application metadata, etc., and may use the context information for facilitating a conversation with user 120. For instance, responsive to user 120 interacting with widget 191, machine learning module 110 may generate a response such as, “Sure! At 1:22 the host introduces the color-blocking trick, and at 3:47 she demonstrates the peel-and-stick panels that transform the accent wall,” which may be provided as audio output by UI components 102. In some examples, the response may also be provided as text output, e.g., widget 109B, which may be a minimized version of widget 109A of FIG. 1A, and may be expanded to include the text response. In this way, user 120 may be provided an opportunity to engage with and receive assistance from machine learning module 110, e.g., an AI agent, via natural, voice-based conversation.

Furthermore, in some examples, user 120 may interact with machine learning module 110, e.g., an AI agent, “hands-free;” that is, responsive to user 120 interacting with widget 191, user 120 may then provide input and receive output from machine learning module 110 without having to provide additional touch-based input. However, in some examples, user 120 may not be required to provide a touch-based input at all to initiate conversation with and/or receive output from machine learning module 110, e.g., an AI agent. Rather, in some examples, user 120 may speak a command out loud, which may include one or more “trigger” words that may cause a conversation with machine learning module 110 to be initiated and/or output to be generated by machine learning module 110. In some other examples, the conversation may be initiated and/or output may be generated based on machine learning module 110 identifying detected input (e.g., user 120's speech) that has a threshold level of association with the content currently being presented on GUI 103. For example, without providing a touch-based input, user 120 may say aloud a natural language input such as, “Find me videos similar to this one.” Machine learning module 110 may determine the natural language input has the threshold level of association with the content currently being presented on GUI 103 (e.g., the video), and therefore may proceed to generate output based on the natural language input.

In this way, users may simply interact with a widget to provide a natural language input, such as a query pertaining to the content of a current GUI, and receive output that answers their query. As such, the techniques described herein may provide users a “shortcut” for performing actions and answering their own queries, as they may not be required to have to navigate through all of the content of a current GUI, e.g., watching an entire video, navigating through descriptions, comment sections, etc. in order to find relevant information for their queries. Furthermore, various aspects of the techniques described in this disclosure may facilitate better user experience with applications executing on user devices, as an easily accessible floating overlay widget (e.g., widget 109A or widget 109B) may help reduce the amount of time and effort required by a user to access or discover information included in the large amount of content hosted on an application and/or application GUI. The techniques described may also provide more assistance to users with disabilities when interacting with devices and applications.

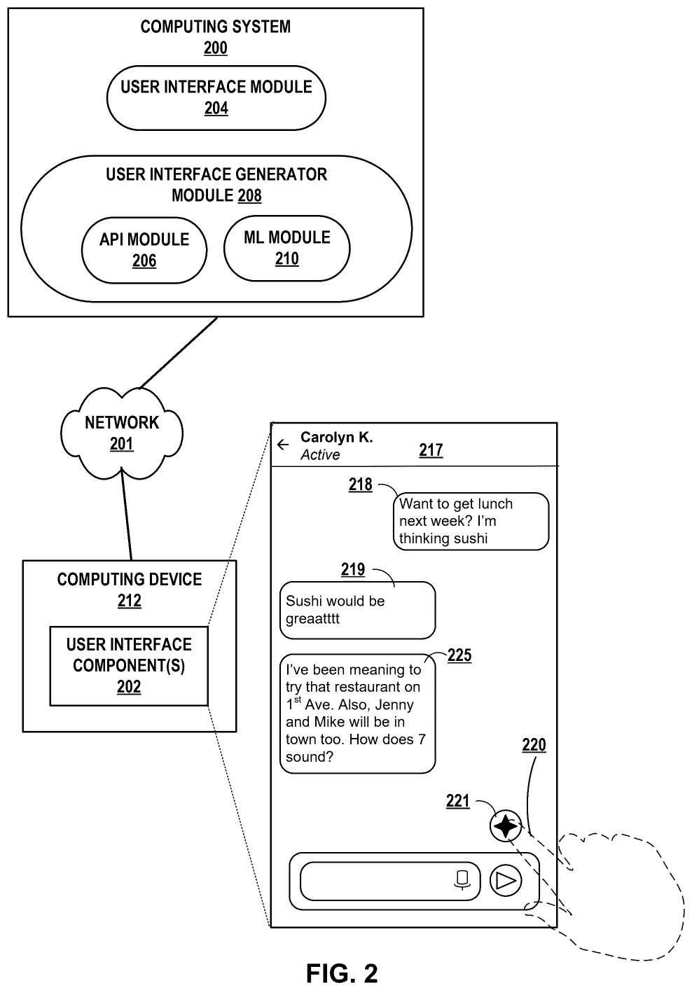

FIG. 2 is a conceptual diagram illustrating another example computing system for receiving input and content of a current application graphical user interface to dynamically generate suggested output and corresponding graphical components, in accordance with one or more techniques of this disclosure. In some examples, determining the at least one prompt may be based on information associated with at least the portion of the content, in which computing system 200 applies machine learning module 210 to the information associated with at least the portion of the content to determine the at least one prompt. For example, in the example of FIG. 2, a current frame of a messaging application GUI 217 may include text messages such as text message 218, “Want to get lunch next week? I'm thinking sushi,” text message 219, “Sushi would be greaatttt,” and text message 225, “I've been meaning to try that restaurant on 1st Ave. Also, Jenny and Mike will be in town too. How does 7 PM sound?” In some examples, computing system 200 may retrieve the content information responsive to receiving an indication of an input from computing device 212, such as indication of a tactile event, e.g., user 220 interacting with button 221, which may be a button designated for triggering the techniques described herein with respect to computing system 200. Computing system 200 may retrieve the content information of the current frame (e.g., a portion of GUI 217), such as the text messages, and apply machine learning module 210 (e.g., a large language model) to the content information to determine at least one prompt, such as an implicitly stated prompt, “Book a reservation at the restaurant on 1st Ave for 4 people at 7 PM.” That is, the content of the text messages displayed on GUI 217, and/or other content, may include natural language text that can be provided as input to and processed by machine learning module 210 (which may include a large language model). Similar to the example of FIGS. 1A-1B, computing system 200 may further apply machine learning module 210 to the at least one prompt and the retrieved content information to determine at least one suggested output.

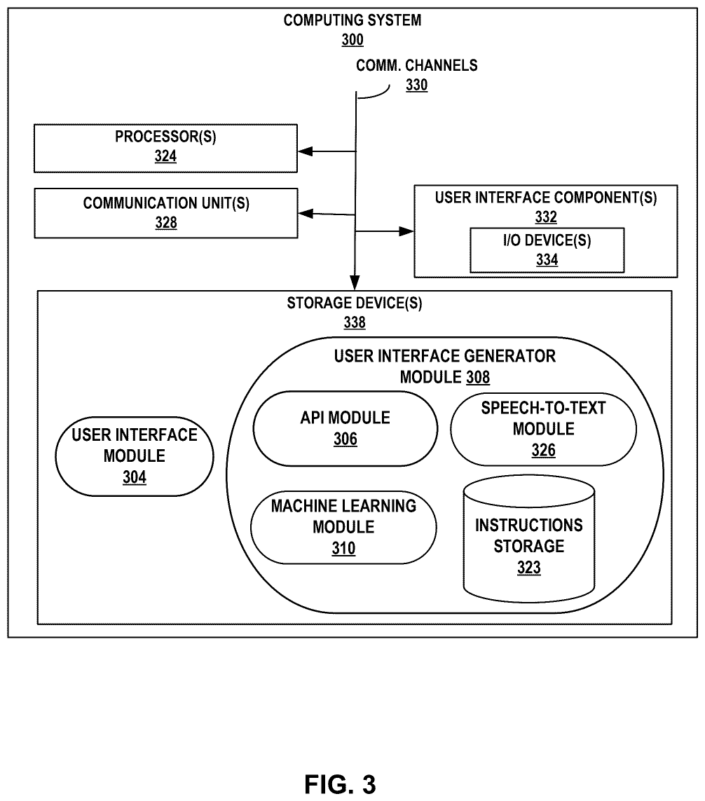

FIG. 3 is a block diagram illustrating another example computing system configured to apply a machine learning module to input and content of a current application graphical user interface to dynamically generate suggested output and corresponding graphical components, in accordance with one or more techniques of this disclosure. As shown in the example of FIG. 3, computing system 300 includes processors 324, one or more communication channels 330, one or more user interface components (UIC) 332, one or more communication units 328, and one or more storage devices 338. Storage devices 338 of computing system 300 may include user interface module 304, and user interface generator module 308. As shown in the example of FIG. 3, user interface generator module 308 further includes API module 306, machine learning module 310, speech-to-text module 326, and instructions storage 323.

Some or all of the components and/or functionality attributed to computing system 300 may be implemented or performed by a computing device in communication with computing system 300. Computing system 300, user interface module 304, user interface generator module 308, API module 306, machine learning module 310, and user interface (UI) components 332 may be similar if not substantially similar to computing system 100, user interface module 104, user interface generator module 108, API module 106, machine learning module 110, and user interface (UI) components 102 of FIG. 1A, respectively.

The one or more communication units 328 of computing system 300, for example, may communicate with external devices by transmitting and/or receiving data at computing system 300, such as to and from remote computer systems or computing devices. Example communication units 328 include a network interface card (e.g., such as an Ethernet card), an optical transceiver, a radio frequency transceiver, or any other type of device that can send and/or receive information. Other examples of communication units 328 may be devices configured to transmit and receive Ultrawideband®, Bluetooth®, GPS, 3G, 4G, and Wi-Fi®, etc. that may be found in computing devices, such as mobile devices and the like.

As shown in the example of FIG. 3, communication channels 330 may interconnect each of the components as shown for inter-component communications (physically, communicatively, and/or operatively). In some examples, communication channels 330 may include a system bus, a network connection (e.g., to a wireless connection), one or more inter-process communication data structures, or any other components for communicating data between hardware and/or software locally or remotely.

One or more I/O devices 334 of computing system 300 may receive inputs and generate outputs. Examples of inputs are tactile, audio, kinetic, and optical input, to name only a few examples. Input devices of I/O devices 334, in one example, may include a touchscreen, a touchpad, a mouse, a keyboard, a voice responsive system, a video camera, buttons, a control pad, a microphone or any other type of device for detecting input from a human or machine. Output devices of I/O devices 334, may include, a sound card, a video graphics adapter card, a speaker, a display, or any other type of device for generating output to a human or machine.

User interface module 304, user interface generator module 308, API module 306, machine learning module 310, speech-to-text module 326, and instructions storage 323 (hereinafter “modules 304-326”) may perform operations described herein using software, hardware, firmware, or a mixture of hardware, software, and firmware residing in and executing on computing system 300 or at one or more other computing devices (e.g., a cloud-based application—not shown). For example, some or all of modules 304-326 may be included in an executable on a local computing device, such as computing device 112 of FIG. 1A. As such, the techniques described herein may all be implemented locally on a computing device.

Computing system 300 may execute one or more of modules 304-326, with one or more processors 324 or may execute any or part of one or more of modules 304-326 as or within a virtual machine executing on underlying hardware. One or more of modules 304-326 may be implemented in various ways, for example, as a downloadable or pre-installed application, remotely as a cloud application, or as part of the operating system of computing system 300. Other examples of computing system 300 that implement techniques of this disclosure may include additional components not shown in FIG. 3.

In the example of FIG. 3, one or more processors 324 may implement functionality and/or execute instructions within computing system 300. For example, one or more processors 324 may receive and execute instructions that provide the functionality of UIC 332, communication units 328, one or more storage devices 338 and an operating system to perform one or more operations as described herein. For example, one or more processors 324 may receive and execute instructions that provide the functionality of some or all of modules 304-326 to perform one or more operations and various functions described herein. The one or more processors 324 include a central processing unit (CPU). Examples of CPUs include, but are not limited to, a digital signal processor (DSP), a general-purpose microprocessor, a tensor processing unit (TPU); a neural processing unit (NPU); a neural processing engine; a core of a CPU, VPU, GPU, TPU, NPU or another processing device, an application specific integrated circuit (ASIC), a field programmable logic array (FPGA), or other equivalent integrated or discrete logic circuitry, or other equivalent integrated or discrete logic circuitry.

One or more storage devices 338 within computing system 300 may store information, such as information retrieved from a user computing device, or other data discussed herein, for processing during the operation of computing system 300. In some examples, one or more storage devices of storage devices 338 may be a volatile or temporary memory. Examples of volatile memories include random access memories (RAM), dynamic random-access memories (DRAM), static random-access memories (SRAM), and other forms of volatile memories known in the art. Storage devices 338, in some examples, may also include one or more computer-readable storage media. Storage devices 338 may be configured to store larger amounts of information for longer terms in non-volatile memory than volatile memory. Examples of non-volatile memories include magnetic hard disks, optical discs, flash memories, or forms of electrically programmable memories (EPROM) or electrically erasable and programmable (EEPROM) memories. Storage devices 338 may store program instructions and/or data associated with the modules 304-326 of FIG. 3.

In general, with explicit consent from a user, computing system 300 may retrieve, using API module 306, information associated with at least a portion of content included in a current GUI. UI module 304 may receive an indication of an input detected at a location of an input device that corresponds to a graphical component included in the GUI. In some examples, computing system 300 may retrieve data, e.g., user data, and/or context information from an application executing at the computing device, and/or the computing device itself. For example, the context information may include, but is not limited to, device location data, device information, network information, connectivity information, application usage data, environmental data, user preference data, battery status, sensor data, application permissions, calendar events, notification data, etc. The indication of the input may be associated with at least a portion of the content included in the GUI. For example, the natural language user input may include an utterance such as, “What is the pet policy in this PDF?” which may be associated with the textual content included in a PDF document.

In some examples, the indication of the input may be received by UI module 304 from the computing device in response to a gesture detected at a location of a presence-sensitive display of the computing device. In other words, a user may use a “touch and talk” feature on the computing device, in which the indication of a natural language user input is captured by the computing device and sent to UI module 304. UI module 304 may further interpret the indication or other inputs detected at the computing device. UI module 304 may relay information about the inputs detected at the computing device to one or more associated platforms, operating systems, applications, and/or services executing at the computing device to cause the computing device to perform a function. For example, if UI module 304 is unable to interpret the indication or other inputs, UI module 304 may relay information to the computing device in which the computing device may request the user to repeat or clarify the indication or other inputs. In some examples, UI module 304 may determine whether the indication of a natural language user input is associated with the content of the GUI. In other words, UI module 304 may determine whether the indication and/or other inputs are associated with the information, capabilities and/or functionalities included in the GUI or the application associated with the GUI. UI module 304 may determine that output pertaining to a prompt cannot be generated by computing system 300. UI module 304 may then relay information to the computing device indicating this error, in which the computing device may further relay this error to the user.

UI module 304 may also receive information and instructions from one or more associated platforms, operating systems, applications, and/or services executing at the computing device (e.g., user interface generator module 308) for generating a file comprising instructions for generating a second plurality of graphical components, in which the second plurality of graphical components is associated with the one or more suggested outputs. In some examples, UI module 304 may act as an intermediary between the one or more associated platforms, operating systems, applications, and/or services executing at the computing device and various output devices of the computing device (e.g., speakers, LED indicators, vibrators, etc.) to produce output (e.g., graphical, audible, tactile, etc.) with the computing device.

In some examples, user interface generator module 308 may be implemented on a computing device in various ways. For example, user interface generator module 308 may be implemented as a downloadable or pre-installed application or “app.” In another example, user interface generator module 308 may be implemented as part of an operating system of a computing device.

Instructions storage 323 is a storage repository for information retrieved by API module 306, such as information associated with at least a portion of content included in a current GUI. Instructions storage 323 may also store, with explicit user consent, context data and/or other data (e.g., user data) retrieved from a computing device by API module 206. Information may be stored in instructions storage 323 for use by other modules of user interface generator module 308, such as machine learning module 310. In some examples, instructions storage 323 may operate, at least in part, as a cache for instructions retrieved from a computing device (e.g., using one or more communication units 328) or other computing devices. In general, instructions storage 323 may be configured as a database, flat file, table, or other data structure stored within storage device 338. In some examples, instructions storage 323 is shared between various modules executing at computing system 300 (e.g., between one or more of modules 304-326 or other modules not shown in FIG. 3). In other examples, a different data repository is configured for a module executing at computing system 300 that requires a data repository. Each data repository may be configured and managed by different modules and may store data in a different manner. In some examples, computing system 300 may receive and store information from a computing device over a specified period of time.

In the example of FIG. 3, user interface generator module 308 may receive, from UI module 304, the indication of an input, which may be a natural language audio or text input from a user operating a computing device. In examples where the user input is an audio input (e.g., comprising spoken language), speech-to-text module 326 may convert the input into a computer-readable format. Speech-to-text module 326 may implement an Automatic Speech Recognition (ASR) system to convert an audio input (e.g., a digital audio signal) into written text. In some examples, speech-to-text module 326 may preprocess the audio input to enhance quality and remove noise by normalizing the audio volume and filtering out any background noise. Speech-to-text module 326 may then transform the audio input into a more suitable format and extract features such as Mel-frequency cepstral coefficients (MFCCs), which capture information about the frequency content of the audio signal over short time intervals. In some examples, speech-to-text module 326 may perform acoustic modeling (e.g., with Hidden Markov Models (HMMs)), which may involve training a statistical model that maps the extracted audio features to phonemes. The acoustic model may learn to associate specific audio features with phonemes while taking into account the variations in pronunciation, accents, and speaking styles. In some examples, speech-to-text module 326 may further implement language modeling (e.g., deep learning techniques, such as recurrent neural networks (RNNs) and transformers) to capture and predict a sequence of words or phrases while considering the context in which the words are spoken (e.g., speech-to-text module 326 may use context information received by UI module 304). Speech-to-text module 326 may further use the trained acoustic and language models to decode the audio input and generate a transcription or sequence of words that best match the observed audio features. Speech-to-text module 326 may further implement post-processing techniques (e.g., grammar checks, contextual analysis, spell correction, etc.) to refine the transcription and improve readability and accuracy. Speech-to-text module 326 may then output the transcribed text that represents the audio input to machine learning module 310 for further processing and analysis.

In general, machine learning module 310 may be configured to interpret both text and audio input received by UI module 304, such as to identify at least one prompt associated with at least the portion of the content. In some examples, machine learning module 310 may be configured to infer any indication of a natural language user input. In other words, machine learning module 310 may infer capabilities from user intents. In some examples, machine learning module 310 may search capabilities. In some examples, machine learning module 310 may convert the audio or text input received by UI module 304, the transcribed text output from speech-to-text module 326, and/or information stored in instructions storage 323 into structured text. For example, machine learning module 310 may convert any input or information to an extensible Markup Language (XML), or other structured text types, such as, but not limited to, HTML, JSON, CSV, INI Files, etc. In this way, the information and input received by user interface generator module 308 can be provided to ML module 310 in a standardized format. Furthermore, in some examples, machine learning module 310 may determine the type of information to include in the structured text representation. More specifically, machine learning module 310 may analyze various application functionalities, capabilities, and attributes included in the information stored in instructions storage 323, such as content descriptions, roles, states, actions, and/or other relevant properties of user interface elements, the contextual information associated with the user input, the audio or text input received by UI module 304, and/or the transcribed text output from speech-to-text module 326.

In some implementations, as discussed above, the received indication of the natural language user input may be preprocessed. In some examples, the information stored in instructions storage 323 may be preprocessed. Preprocessing techniques may include extracting one or more additional features from raw data. For example, feature extraction techniques may be applied to the user input or retrieved instructions to generate one or more new, additional features.

In general, machine learning module 310 may employ a large language model (LLM) that can interpret the indication of natural language user input to identify at least one prompt, interpret at least a portion of the content included in a current GUI, and, determine, based on the at least one prompt and at least the portion of the content, one or more suggested outputs. In some examples, machine learning module 310 may implement other machine-learned models that may be used in place of or in conjunction with LLM model that is described with respect to FIG. 3. Machine learning module 310 may perform various types of natural language processing (NLP) based on the indication of the natural language user input. The indication of the natural language user input, the retrieved first set of instructions, context information, and/or other data (e.g., user data) received by computing system 300 may be referred to herein as “input data”. For example, machine learning module 310 may summarize, translate, or organize the input data. Machine learning module 310 may use recurrent neural networks (RNNs) and/or transformer models (self-attention models), such as GPT-3, BERT, and T5. In some implementations, machine learning module 310 may perform classification, summarization, name generation, regression, clustering, anomaly detection, recommendation generation, and/or other tasks.

In some implementations, machine learning module 310 may perform various types of classification based on the input data. For example, machine learning module 310 may perform binary classification or multiclass classification. In binary classification, the output data may include a classification of the input data into one of two different classes. In multiclass classification, the output data may include a classification of the input data into one (or more) of more than two classes. The classifications may be single-label or multi-label. Machine learning module 310 may perform discrete categorical classification in which the input data is simply classified into one or more classes or categories.

In cases in which machine learning module 310 performs classification, machine learning module 310 may be trained using supervised learning techniques. For example, machine learning module 310 may be trained on a training dataset that includes training examples labeled as belonging (or not belonging) to one or more classes.

In some implementations, machine learning module 310 may perform regression to provide output data in the form of a continuous numeric value. The continuous numeric value may correspond to any number of different metrics or numeric representations, including, for example, currency values, scores, or other numeric representations. In examples, machine learning module 310 may perform linear regression, polynomial regression, or nonlinear regression. In examples, machine learning module 310 may perform simple regression or multiple regression. In some implementations, a Softmax function or other function or layer may be used to squash a set of real values respectively associated with two or more possible classes to a set of real values in the range (0, 1) that sum to one.

Machine learning module 310 may perform various types of clustering. For example, machine learning module 310 may identify one or more clusters to which the input data most likely corresponds. Machine learning module 310 may identify one or more clusters within the input data. That is, in instances in which the input data includes multiple objects, documents, or other entities, machine learning module 310 may sort the multiple entities included in the input data into a number of clusters. In some implementations in which machine learning module 310 performs clustering, machine learning module 310 may be trained using unsupervised learning techniques.

Machine learning module 310 may, in some cases, act as an agent within an environment. For example, machine learning module 310 may be trained using reinforcement learning, which will be discussed in further detail below.

In some implementations, machine learning module 310 may include a parametric model while, in other implementations, machine learning module 310 may include a non-parametric model. In some implementations, machine learning module 310 may include a linear model while, in other implementations, machine learning module 310 may include a non-linear model.

Machine learning module 310 may be or include one or more of various different types of machine-learned models. Examples of such different types of machine-learned models are provided below for illustration. One or more of the example models described below may be used (e.g., combined) to provide the output data in response to the input data. Additional models beyond the example models provided below may be used as well.

In some implementations, machine learning module 310 may be or include one or more classifier models such as, for example, linear classification models; quadratic classification models; etc. Machine learning module 310 may be or include one or more regression models such as, for example, simple linear regression models; multiple linear regression models; logistic regression models; stepwise regression models; multivariate adaptive regression splines; locally estimated scatterplot smoothing models; etc.

In some implementations, machine learning module 310 may be or include one or more artificial neural networks (also referred to simply as neural networks). A neural network may include a group of connected nodes, which also may be referred to as neurons or perceptrons. A neural network may be organized into one or more layers. Neural networks that include multiple layers may be referred to as “deep” networks. A deep network may include an input layer, an output layer, and one or more hidden layers positioned between the input layer and the output layer. The nodes of the neural network may be connected or non-fully connected.

In some examples, machine learning module 310 may be or include one or more generative networks such as, for example, generative adversarial networks. Generative networks may be used to generate new data such as artificial feedback texts.

In an example in which the input data does not include feature embeddings, one or more neural networks may be used to provide an embedding based on the input data. For example, the embedding may be a representation of knowledge abstracted from the input data into one or more learned dimensions. In some instances, embeddings may be a useful source for identifying related entities. In some instances, embeddings may be extracted from the output of the network, while in other instances embeddings may be extracted from any hidden node or layer of the network (e.g., a close to final but not final layer of the network). Embeddings may be useful for performing auto-suggest next video, product suggestion, entity or object recognition, etc. In some instances, embeddings are useful inputs for downstream models. For example, embeddings may be useful to generalize input data (e.g., search queries) for a downstream model or processing system.

In some implementations, machine learning module 310 may perform or be subjected to one or more reinforcement learning techniques such as Markov decision processes; dynamic programming; Q functions or Q-learning; value function approaches; deep Q-networks; differentiable neural computers; asynchronous advantage actor-critics; deterministic policy gradient; etc.

In some implementations, machine learning module 310 may be an autoregressive model. In some instances, an autoregressive model may specify that the output data depends linearly on its own previous values and on a stochastic term. In some instances, an autoregressive model may take the form of a stochastic difference equation. One example of an autoregressive model is WaveNet, which is a generative model for raw audio.

In some implementations, machine learning module 310 may include or form part of a multiple model ensemble. As one example, bootstrap aggregating may be performed, which may also be referred to as “bagging.” In bootstrap aggregating, a training dataset is split into a number of subsets (e.g., through random sampling with replacement) and a plurality of models are respectively trained on the number of subsets. At inference time, respective outputs of the plurality of models may be combined (e.g., through averaging, voting, or other techniques) and used as the output of the ensemble.

One example ensemble is a random forest, which may also be referred to as a random decision forest. Random forests are an ensemble learning method for classification, regression, and other tasks. Random forests are generated by producing a plurality of decision trees at training time. In some instances, at inference time, the class that is the mode of the classes (classification) or the mean prediction (regression) of the individual trees may be used as the output of the forest. Random decision forests may correct for decision trees' tendency to overfit their training set.

Another example ensemble technique is stacking, which can, in some instances, be referred to as stacked generalization. Stacking includes training a combiner model to blend or otherwise combine the predictions of several other machine-learned models. Thus, a plurality of machine-learned models (e.g., of the same or different type) may be trained based on training data. In addition, a combiner model may be trained to take the predictions from the other machine-learned models as inputs and, in response, produce a final inference or prediction. In some instances, a single-layer logistic regression model may be used as the combiner model.

Another example of ensemble techniques is boosting. Boosting may include incrementally building an ensemble by iteratively training weak models and then adding to a final strong model. For example, in some instances, each new model may be trained to emphasize the training examples that previous models misinterpreted (e.g., misclassified). For example, a weight associated with each of such misinterpreted examples may be increased. One common implementation of boosting is AdaBoost, which may also be referred to as Adaptive Boosting. Other example boosting techniques include LPBoost; TotalBoost; BrownBoost; xgboost; MadaBoost, LogitBoost, gradient boosting; etc. Furthermore, any of the models described above (e.g., regression models and artificial neural networks) may be combined to form an ensemble. As an example, an ensemble may include a top-level machine-learned model or a heuristic function to combine and/or weight the outputs of the models that form the ensemble.

In some implementations, multiple machine-learned models (e.g., that form an ensemble may be linked and trained jointly (e.g., through backpropagation of errors sequentially through the model ensemble). However, in some implementations, only a subset (e.g., one) of the jointly trained models is used for inference.

In some implementations, machine learning module 310 may be used to preprocess the input data for subsequent input into another model. For example, machine learning module 310 may perform dimensionality reduction techniques and embeddings (e.g., matrix factorization, principal components analysis, singular value decomposition, word3vec/GLOVE, and/or related approaches); clustering; and even classification and regression for downstream consumption. Many of these techniques have been discussed above and will be further discussed below.

In some implementations, during training, the input data may be intentionally deformed in any number of ways to increase model robustness, generalization, or other qualities. Example techniques to deform the input data include adding noise; changing color, shade, or hue; magnification; segmentation; amplification; etc.

In response to receipt of the input data, machine learning module 310 may provide the output data. As examples, in various implementations, the output data may include content, either stored locally on the user device or in the cloud, that is relevantly shareable along with the initial content selection.

In some implementations, the output data may influence downstream processes or decision-making. As one example, in some implementations, the output data, or the second set of instructions, may be interpreted and/or acted upon by a rules-based regulator.

The techniques of the present disclosure may be implemented by or otherwise executed on one or more computing devices (e.g., computing device 112 of FIG. 1A). Examples of such computing devices include user computing devices (e.g., laptops, desktops, and mobile computing devices such as tablets, smartphones, wearable computing devices, etc.); embedded computing devices (e.g., devices embedded within a vehicle, camera, image sensor, industrial machine, satellite, gaming console or controller, or home appliance such as a refrigerator, thermostat, energy meter, home energy manager, smart home assistant, etc.); other computing devices; or combinations thereof. Computing system 300 that implements machine learning module 310 or other aspects of the present disclosure may include a number of hardware components that enable the performance of the techniques described herein.

Machine learning module 310 may be trained according to one or more of various different training types or techniques. For example, in some implementations, machine learning module 310 may be trained using supervised learning, in which machine learning module 310 is trained on a training dataset that includes instances or examples that have labels. The labels may be manually applied by experts, generated through crowdsourcing, or provided by other techniques (e.g., by physics-based or complex mathematical models). In some implementations, if the user has provided consent, the training examples may be provided by the user computing device. In some implementations, this process may be referred to as personalizing the model.

In some implementations, backward propagation of errors may be used in conjunction with an optimization technique (e.g., gradient-based techniques) to train machine learning module 310 (e.g., when the machine-learned model is a multi-layer model such as an artificial neural network). For example, an iterative cycle of propagation and model parameter (e.g., weights) update may be performed to train machine learning module 310. Example backpropagation techniques include truncated backpropagation through time, Levenberg-Marquardt backpropagation, etc.

In some implementations, machine learning module 310 may be trained using unsupervised learning techniques. Unsupervised learning may include inferring a function to describe hidden structure from unlabeled data. For example, a classification or categorization may not be included in the data. Unsupervised learning techniques may be used to produce machine-learned models capable of performing clustering, anomaly detection, learning latent variable models, or other tasks.

Machine learning module 310 may be trained using semi-supervised techniques which combine aspects of supervised learning and unsupervised learning. Machine learning module 310 may be trained or otherwise generated through evolutionary techniques or genetic algorithms. In some implementations, machine learning module 310 may be trained using reinforcement learning. In reinforcement learning, an agent (e.g., model) may take actions in an environment and learn to maximize rewards and/or minimize penalties that result from such actions. Reinforcement learning may differ from the supervised learning problem in that correct input/output pairs are not presented, nor sub-optimal actions explicitly corrected.

In some implementations, one or more generalization techniques may be performed during training to improve the generalization of machine learning module 310. Generalization techniques may help reduce overfitting of machine learning module 310 to the training data. Example generalization techniques include dropout techniques; weight decay techniques; batch normalization; early stopping; subset selection; stepwise selection; label smoothing; etc.

In some implementations, machine learning module 310 may include or otherwise be impacted by a number of hyperparameters, such as, for example, learning rate, number of layers, number of nodes in each layer, number of leaves in a tree, number of clusters; etc. Hyperparameters may affect model performance. Hyperparameters may be hand selected or may be automatically selected through the application of techniques such as, for example, grid search; black-box optimization techniques (e.g., Bayesian optimization, random search, etc.); gradient-based optimization; etc. Example techniques and/or tools for performing automatic hyperparameter optimization include Hyperopt; Auto-WEKA; Spearmint; Metric Optimization Engine (MOE); etc.

In some implementations, various techniques may be used to optimize and/or adapt the learning rate when the model is trained. Example techniques and/or tools for performing learning rate optimization or adaptation include Adagrad; Adaptive Moment Estimation (ADAM); Adadelta; RMSprop; etc.

In some implementations, transfer learning techniques may be used to provide an initial model from which to begin training of machine learning module 310.

In some implementations, machine learning module 310 may be included in different portions of computer-readable code on a computing device. In one example, machine learning module 310 may be included in a particular application or program and used (e.g., exclusively) by such particular application or program. Thus, in one example, a computing device may include a number of applications, and one or more of such applications may contain its own respective machine learning library and machine-learned model(s).

In another example, machine learning module 310 may be included in an operating system of a computing device (e.g., in a central intelligence layer of an operating system) and may be called or otherwise used by one or more applications that interact with the operating system. In some implementations, each application may communicate with the central intelligence layer (and model(s) stored therein) using an application programming interface (API) (e.g., a common, public API across all applications).

In some implementations, the central intelligence layer may communicate with a central device data layer. The central device data layer may be a centralized repository of data for the computing device. The central device data layer may communicate with a number of other components of the computing device, such as, for example, one or more sensors, a context manager, a device state component, and/or additional components. In some implementations, the central device data layer may communicate with each device component using an API (e.g., a private API).

The technology discussed herein refers to servers, databases, software applications, and other computer-based systems, as well as actions taken, and information sent to and from such systems. The inherent flexibility of computer-based systems allows for a great variety of possible configurations, combinations, and divisions of tasks and functionality between and among components. For instance, processes discussed herein may be implemented using a single device or component or multiple devices or components working in combination.

Databases and applications may be implemented on a single system or distributed across multiple systems. Distributed components may operate sequentially or in parallel.

In addition, the machine learning techniques are readily interchangeable and combinable. Although certain example techniques have been described, many others exist and may be used in conjunction with aspects of the present disclosure.

In some implementations, transfer learning (TL) may be used. Transfer learning involves reusing a model and its model parameters obtained while solving one problem and applying it to a different but related problem. Models trained on very large data sets may be retrained or fine-tuned on additional data. Often, all model designs and their parameters on a source model are copied except output layer(s). The output layers(s) are often called the head, and other layers are often called the base. The source parameters may be considered to contain the knowledge learned from the source dataset and this knowledge may also be applicable to a target dataset. Fine-tuning may include updating the head parameters with the body parameters being fixed or updated in a later step.

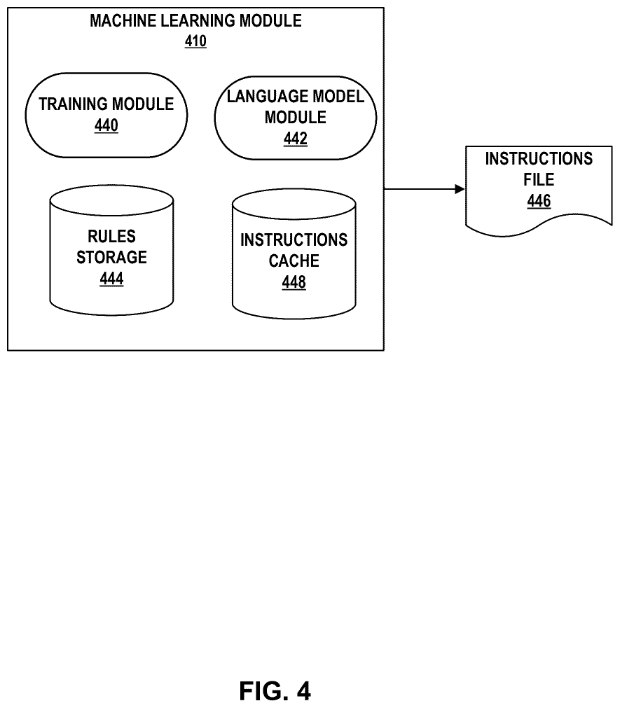

Thus, machine learning module 310 may apply one or more of the machine learning techniques described above to the input data. As described further below with respect to FIG. 4, in some examples, machine learning module 310 may apply a language model to the indication of natural language user input to identify one or more prompts.

FIG. 4 is a conceptual diagram illustrating a machine learning module configured to apply a large language model that accepts natural language input and provides suggested output and code for corresponding graphical components, in accordance with one or more techniques of this disclosure. In general, ML module 410 can be or include one or more transformer-based neural networks, such as a large language model module 442. Language model module 442 may implement, for example, the Pathways Language Model developed by Google. Transformer-based neural networks may refer to a type of deep learning architecture specifically designed for handling sequential data, such as text or time series. In other words, transformer-based neural networks like LLMs may be configured to perform natural language processing (NLP) tasks, such as question-answering, machine translation, text summarization, and sentiment analysis. Language model module 442 may be configured to perform tasks such as classification, sentiment analysis, entity extraction, extractive question answering, summarization, re-writing text in a different style, ad copy generation, and concept ideation.

Transformer-based neural networks may utilize a self-attention mechanism, which allows the model to weigh the importance of different elements in a given input sequence relative to each other. The self-attention mechanism may help language model module 442 effectively capture long-range dependencies and complex relationships between elements, such as words in a sentence.

Language model module 442 may include an encoder and a decoder that operate to process and generate sequential data, such as structured text. Both the encoder and decoder may include one or more of self-attention mechanisms, position-wise feedforward networks, layer normalization, or residual connections. In some examples, the encoder may process an input sequence and create a representation that captures the relationships and context among the elements in the sequence. The decoder may then obtain the representation generated by the encoder and produce an output sequence. In some examples, the decoder may generate the output one element at a time (e.g., one word at a time), using a process called autoregressive decoding, where the previously generated elements are used as input to predict the next element in the sequence.

In some examples, if user intent is unclear, machine learning module 410 may be unable to determine the user's intent with high confidence. In such instances, instructions file 446, which includes the set of instructions, may include instructions for prompting the user to clarify their input. In general, language model module 442 may apply an LLM to an indication of natural language user input and/or retrieved content information to identify one or more prompts.

In some examples, language model module 442 may determine a set of information types included in the input (e.g., text or audio input or a transcription generated by speech-to-text module 226). An information type may be or otherwise include a topic, theme, point, subject, purpose, intent, keyword, etc. In some examples, language model module 442 may determine the information type by leveraging a self-attention mechanism to capture the relationships and dependencies between words in the input sequence. For example, language model module 442 may tokenize (e.g., split) a sequence of words or subwords, which language model module 442 may convert into vectors (e.g., numerical representations) that language model module 442 can process. Language model module 442 may use the self-attention mechanism to weigh the importance of each token in relation to the others. In this way, language model module 442 may identify patterns and relationships between the tokens, and in turn the words corresponding to the tokens, that indicate one or more information types of the accessibility information.

In general, language model module 442 may excel at performing NLP tasks, such as generating text and other content (e.g., new code that provides functionality for performing one or more tasks). However, with respect to specific types of content (e.g., specific information types), language model module 442 may have an increased likelihood of generating false, inaccurate, or bad quality information. To address this issue, language model module 442 may be configured to exclude the generation of content or code relating to a set of excluded information types. For example, the set of excluded information types may include one or more of phone numbers, addresses, web addresses, functionalities prohibited by an application, sensitive data (e.g., full bank account information), etc. Thus, input information may be passed in language model module 442 with certain prerequisites, prompts, or “rules” that can be stored in rules storage 444. Machine learning module 410 may apply these prerequisites, prompts, or rules when generating the set of instructions for generating the second plurality of graphical components associated with the one or more suggested outputs.

For example, machine learning module 410 may implement a rule such as, “Do not include sensitive information” when generating instructions for generating suggested output. In some examples, machine learning module 210 may use accessibility information when generating new code for GUIs and graphical components, such that the user can easily interact with the GUIs and graphical components. In some examples, the rules may be text inputs such as, for example, “Keep answer short.” As such, rules storage 444 may store a plurality of text inputs and/or other data that further specify how instructions file 446 should be generated by machine learning module 410. For example, language model module 442 may be applied to the indication of a natural language user input in accordance with the one or more predefined rules stored in rules storage 444, which may include, for example, unauthorized terms, unauthorized class names, unauthorized dimensions of the graphical user interface, unauthorized application functionalities, etc.

While language model module 442 may be a transformer-based neural network in some examples, in some examples, language model module 442 may be or otherwise include one or more other types of neural networks. For example, language model module 442 may be or include an autoencoder. In some examples, the aim of an autoencoder is to learn a representation (e.g., a lower-dimensional encoding) for a set of data, typically for the purpose of dimensionality reduction. For example, in some examples, an autoencoder can seek to encode the input data and then provide output data that reconstructs the input data from the encoding. In some examples, the autoencoder can include additional losses beyond reconstructing the input data. Language model module 442 may be or include one or more other forms of artificial neural networks such as, for example, deep Boltzmann machines, deep belief networks, stacked autoencoders, etc. Any of the neural networks described herein can be combined (e.g., stacked) to form more complex networks.

In some examples, language model module 442 can be or include one or more feed forward neural networks. In feed forward networks, the connections between nodes do not form a cycle. For example, each connection can connect a node from an earlier layer to a node from a later layer. In some examples, language model module 442 can be or include one or more recurrent neural networks. In some examples, at least some of the nodes of a recurrent neural network can form a cycle.

Recurrent neural networks can be especially useful for processing input data that is sequential in nature. For example, a recurrent neural network can pass or retain information from a previous portion of the input data sequence to a subsequent portion of the input data sequence through the use of recurrent or directed cyclical node connections. Sequential input data may include words in a sentence (e.g., for natural language processing, speech detection or processing, etc.). In some examples, sequential input data can include time-series data (e.g., sensor data versus time or imagery captured at different times). In some examples, sequential input data may include time-series data (e.g., sensor data versus time or imagery captured at different times). For example, a recurrent neural network may analyze sensor data versus time to detect or predict a swipe direction, to perform handwriting recognition, etc. Sequential input data may include words in a sentence (e.g., for natural language processing, speech detection or processing, etc.); notes in a musical composition; sequential actions taken by a user (e.g., to detect or predict sequential application usage); sequential object states; etc.

Example recurrent neural networks may include long short-term (LSTM) recurrent neural networks, gated recurrent units, bi-direction recurrent neural networks, continuous time recurrent neural networks, neural history compressors, echo state networks, Elman networks, Jordan networks, recursive neural networks, Hopfield networks, fully recurrent networks, sequence-to-sequence configurations, etc.

In some examples, language model module 442 can be or include one or more convolutional neural networks. In some examples, a convolutional neural network can include one or more convolutional layers that perform convolutions over input data using learned filters. Filters can also be referred to as kernels. Convolutional neural networks can be especially useful for vision problems such as when the input data includes imagery such as still images or video. However, convolutional neural networks can also be applied for natural language processing.

Machine learning module 410 may include training module 440 that trains (e.g., pre-train, fine-tune, etc.) language model module 442. Training module 440 may pre-train language model module 442 on a large and diverse corpus of text. This dataset may cover a wide range of topics and domains to ensure language model module 442 learns diverse linguistic patterns and contextual relationships. Training module 440 may train language model module 442 to optimize an objective function. The objective function may be or include a loss function, such as cross-entropy loss, that compares (e.g., determines a difference between) output data generated by the model from the training data and labels (e.g., ground-truth labels) associated with the training data. For example, the objective function of language model module 442 may be to correctly predict the next word in a sequence of words or correctly fill in missing words as much as possible.

In some examples, training module 440 may continuously or periodically train language model module 442. In some examples, training module 440 may fine-tune language model module 442 by using feedback in the training process. For example, UI component 302 of FIG. 3 may receive a user input via a computing device that selects feedback (e.g., thumbs up, thumbs down, etc.) relating to the generated application functionality and associated graphical user interface that is presented to the user on the computing device. In some examples, the feedback may indicate whether the generated application functionality and associated graphical user interface is accurate or inaccurate, correct or incorrect, high quality or low quality, etc. UI module 204 may receive this feedback and may send it to user interface generator module 308. User interface generator module 308 may transmit the feedback to machine learning module 210 (specifically to training module 440), in which training module 440 uses the feedback for training. For example, training module 440 may convert the feedback into labeled data for supervised training. Additionally or alternatively, training module 440 may fine-tune language model module 442 by monitoring the relationship between the performance of language model module 442 and user feedback, and iterate the fine-tuning process as necessary (e.g., to receive more positive user feedback and less negative user feedback). In this way, the techniques of this disclosure may establish a feedback loop that continuously improves the quality of the output (i.e., instructions file 446) of language model module 442.

Generally, large language models can be slow and expensive in terms of carbon, energy usage, and financial cost. Thus, in some examples, machine learning module 410 may minimize how often language model module 442 is invoked by caching the generated second set of instructions, or new code, in instructions cache 448. In general, language model module 442 may use a prompt including user intent (e.g., the output from speech-to-text module 326 of FIG. 2) and any contextual information received by the computing system. At runtime, more specific details may be gathered (e.g., via the API), such that the generated second set of instructions or code may be reused. Specifically, machine learning module 410 may be configured to perform instruction embedding in which a representation (i.e., embedding) of frequently used or critical instructions are stored in instructions cache 348.

In various examples, instructions file 446 may be generated based on the instructions stored in instructions cache 448 and any additional instructions, information, or updates retrieved by the API that are not present in instructions cache 448. For example, instructions storage 323 of FIG. 3 or any other local memory may store these additional instructions, information, or updates retrieved by API module 306. Machine learning module 410 may query instructions storage 323 or other local memory to gather these additional instructions, information, or updates and use them with the cached instructions at runtime to generate instructions file 446. By storing frequently used or critical instructions in instructions cache 448, machine learning module 410 may reuse the frequently used or critical instructions without having to invoke language model module 442 on data other than what is included in the prompt (e.g., language model module 442 may not have to re-apply the large language model to the first set of instructions associated with the functions included in the one or more applications). In some examples, the prompt may only include contextual information, and data indicative of user intent may be stored in instructions cache 348. In some examples, machine learning module 410 may apply code caching to both compiled and interpreted languages. Machine learning module 410 may implement various types of caching, such as, for example, Just-In-Time (JIT) compilation, Ahead-Of-Time (AOT) compilation, and bytecode caching.

In general, machine learning module 410 may generate instructions file 446 using language model module 442 and based on the content retrieved from a current GUI and one or more identified prompts (e.g., prompts based on the natural language audio or text input received by the computing system, and/or the transcribed text output from a speech-to-text module). As such, machine learning module 410 may apply language model module 442 to received input (e.g., natural language audio and/or text input) and content of a current application GUI (which may also include natural language text) to determine at least one prompt. Machine learning module 410 may apply language model module 442 to the at least one prompt and the retrieved content to generate instructions file 446, which may include instructions for dynamically generating graphical components that correspond to suggested output. In this way, machine learning module 410 may help to improve user experience, suggested actions, and suggested outputs when interacting with applications, and may provide a “shortcut” for answering and/or performing user queries.

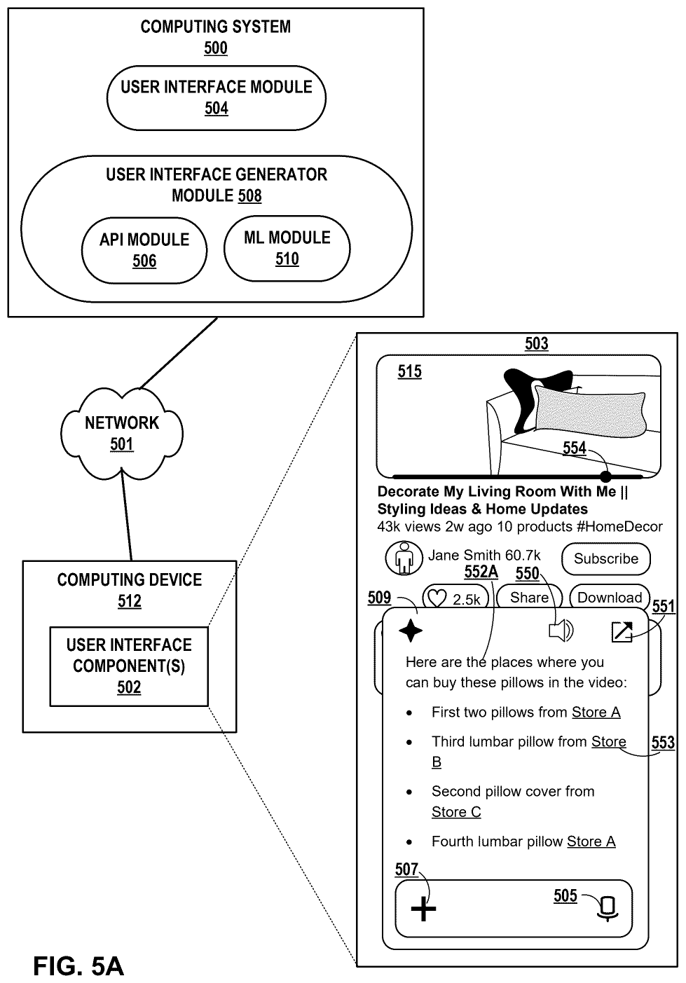

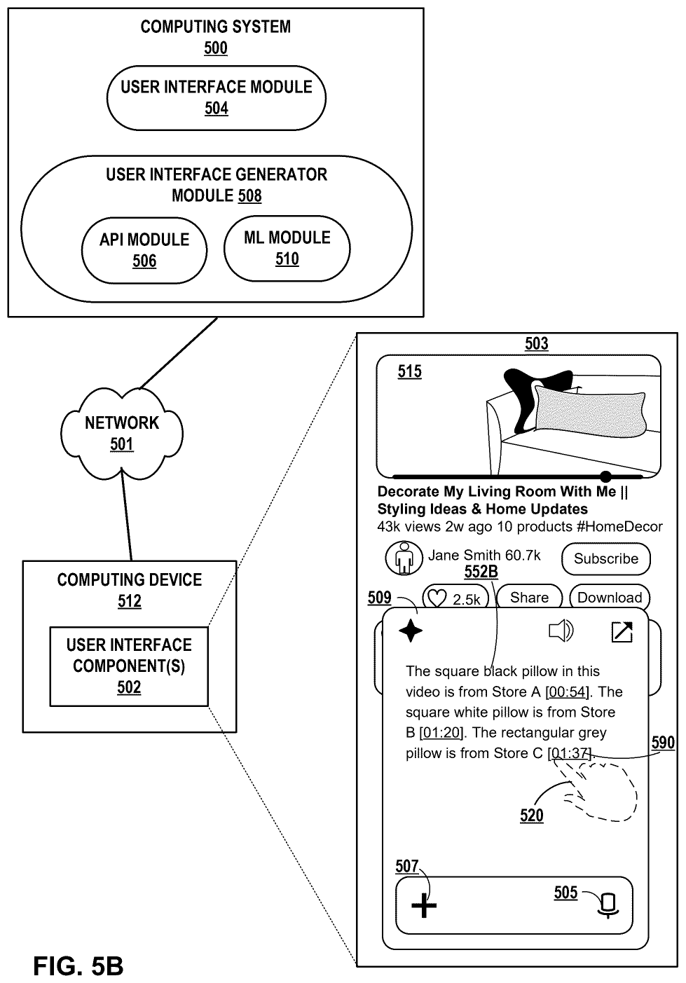

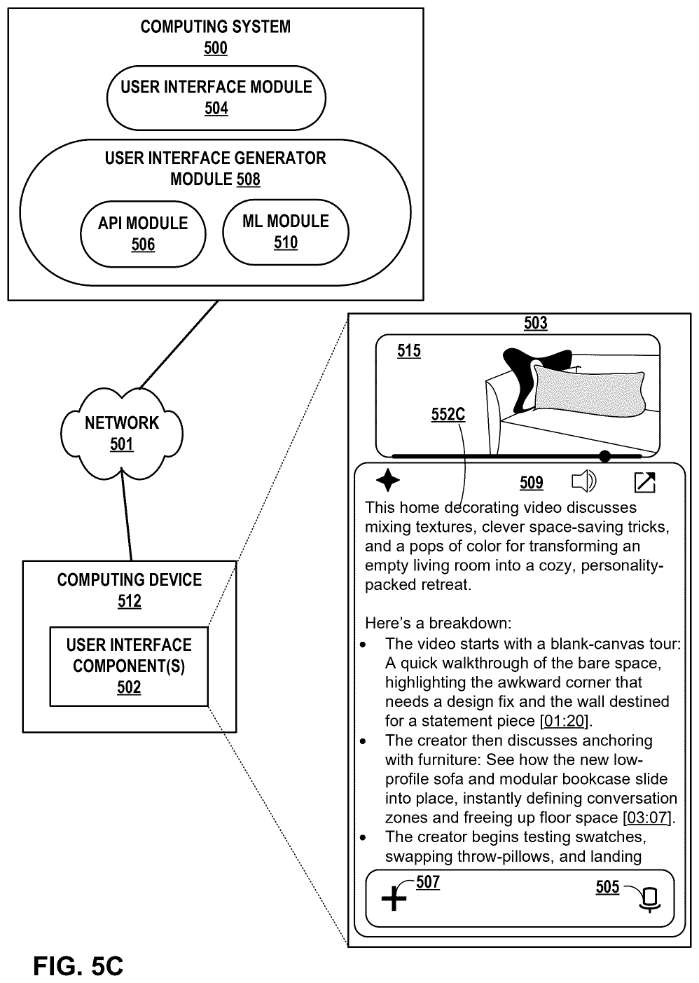

FIGS. 5A-5C are conceptual diagrams illustrating another example computing system for sending suggested output and corresponding graphical components based on at least one prompt, in accordance with one or more techniques of this disclosure. Computing system 500 may be similar if not substantially similar to computing system 100 of FIG. 1A, computing system 200 of FIG. 2, and computing system 300 of FIG. 3. Computing device 512 may be similar if not substantially similar to computing device 112 of FIG. 1A, and computing device 212 of FIG. 2. User interface (UI) components 502 may be similar if not substantially similar to UI components 102 of FIG. 1A and UI components 202 of FIG. 2. Network 501 may be similar if not substantially similar to network 101 of FIG. 1A and network 201 of FIG. 2. GUI 503, video player 515, widget 509, button 507, and microphone button 505 may be similar if not substantially similar to GUI 103, video player 115, widget 109A, button 107, and microphone button 105 of FIG. 1A, respectively. Furthermore, some or all of the techniques described with respect to computing system 500 may be implemented locally on computing device 512.

As shown in the example of FIG. 5A, the instructions generated by computing system 500 may include instructions for generating a second plurality of graphical components, in which the second plurality of graphical components is associated with one or more suggested outputs. For example, the second plurality of graphical components may include speaker button 550, which a user may interact with to play aloud suggested output 552A, and window expander button 551, which may further expand widget 509 into a larger window that displays suggested output 552A. The one or more suggested outputs generated by computing system 500 may include one or more of at least one associated application, the at least one prompt, text, at least one image, and at least one link. As shown in the example of FIG. 5A, suggested output 552A may include text such as, “Here are the places where you can buy these pillows in the video: First two pillows from Store A; Third lumbar pillow from Store B; Second pillow cover from Store C; Fourth lumbar pillow Store A,” in which suggested output 552A may be based on the prompt, “Where can I buy the pillows in this video?” provided in the example of FIG. 1A, and the content of the video played by video player 515. As shown in the example of FIG. 5A, suggested output 552A may include an embedded link, such as embedded link 553, which may be a link associated with the suggested output, e.g., a link to an external site associated with Store B. Furthermore, as shown in the example of FIG. 5A, suggested output 552A may correspond to a determined timestamp 554, which may be a timestamp determined by computing system 500 to be associated with suggested output 552A. In other examples, rather than determining an associated timestamp, computing system 500 may determine other portions of content associated with suggested output 552A, such as portions of a document, associated images, etc. As an example, based on a prompt such as, “What is the pet policy of this contract?”, computing system 500 may generate instructions for generating suggested output that includes text such as, “No pets allowed,” and displaying a highlighted portion of a PDF document where the relevant content is located.

As described herein, in some examples, widget 509 may be considered an expandable widget. That is, in some examples, the instructions for generating the second plurality of graphical components associated with the one or more suggested outputs may further include instructions for transitioning from a first plurality of graphical components to a second plurality of graphical components. For example, widget 109B of FIG. 1B may be representative of the widget in a collapsed state, and widget 509 of FIG. 5A may be representative of the widget in an expanded state. As such, the instructions for transitioning from the first plurality of graphical components to the second plurality of graphical components may further include instructions for transitioning from at least one graphical component in a collapsed state to the at least one graphical component in an expanded state. Furthermore, in some examples, the instructions for transitioning from the at least one graphical component in the collapsed state to the at least one graphical component in the expanded state may be based on an amount of data included in the one or more suggested outputs. As such, the dimensions of widget 509 in FIG. 5A may be smaller or larger, depending on the amount of information included in suggested output 552A.

FIG. 5B illustrates another example of suggested output generated by computing system 500. As shown in FIG. 5B, in some examples, suggested output generated by computing system 500 may include one or more timestamps that link to a specific location within a video. That is, as shown, suggested output 552B may include text such as, “The square black pillow in this video is from Store A [00:54]. The square white pillow is from Store B [01:20]. The rectangular grey pillow is from Store C [01:37],” in which suggested output 552B may be based on the prompt, “Where can I buy the pillows in this video?” provided in the example of FIG. 1A, and the content of the video played by video player 515. As further shown, suggested output 552B may include one or more embedded timestamps, such as embedded timestamp 590, which user 520 may select or click on to adjust the playback of the video played by video player 515. That is, responsive to user 530 selecting embedded timestamp 590, the playback of the video may be adjusted to time 01:37. As such, in some examples, the suggested output generated by computing system 500 may include contextual information that may help users to better understand and/or interact with the suggested output. For instance, suggested output 552B may be a “video-aware” response generated based on information indicative of the video (e.g., video data, such as transcript data, playback position, video metadata, chapter markers, captions, data included in the video description, etc.). In some examples, machine learning module 510 may identify, based on the video information and the prompt, e.g., “Where can I buy the pillows in this video?”, one or more timestamps that correspond to information included in the prompt. That is, in the example of FIG. 5B, machine learning module 510 may identify, based on the video information and the user intent to identify where the pillows featured in the video can be purchased, one or more timestamps (e.g., timestamp 590, which may correspond to a point in the video at which the store from which the rectangular grey pillow was purchased is discussed). In some examples, machine learning module 510 may rank identified timestamps based on relevance to the prompt, in which suggested output 552B may only include the highest-ranked timestamps. In some examples, suggested output 552B may include a range of timestamps that correspond to a portion of the video, e.g., suggested output 552B may include text and timestamps such as “The square black pillow in this video is from Store A [00:54]-[01:15].” As such, in the example of FIG. B. user 520 may not have to manually scrub to find information in the video that answers their query. Instead, suggested output generated by computing system 500 may include timestamps that user 520 may interact with to quickly jump to relevant points of the video that answer their query.

FIG. 5C illustrates another example of suggested output generated by computing system 500. As shown in FIG. 5C, in some examples, suggested output generated by computing system 500 may include a summary of the video played by video player 515. For example, in some examples, widget 509 may be first presented with a suggested input, such as a suggested action for a user to provide as input, e.g., suggested input 111 “Ask about this video” of FIG. 1A. In some examples, a user may provide a natural language input such as, “Summarize this video,” etc. Responsive to the user providing input such as “Ask about this video” or “Summarize this video,” computing system 500 may generate suggested output 552C, which may include a text summary of the video played by video player 515. As shown, suggested output 552C may include text such as, “This home decorating video discusses mixing textures, clever space-saving tricks, and a pops of color for transforming an empty living room into a cozy, personality-packed retreat. Here's a breakdown: The video starts with a blank-canvas tour: A quick walkthrough of the bare space, highlighting the awkward corner that needs a design fix and the wall destined for a statement piece [01:20]. The creator then discusses anchoring with furniture: See how the new low-profile sofa and modular bookcase slide into place, instantly defining conversation zones and freeing up floor space [03:07]. The creator begins testing swatches, swapping throw-pillows, and landing . . . ” As shown in FIG. 3C, in some examples, widget 509 may be expanded to include a larger portion of the suggested output generated by computing system 500. As further shown, in some examples, suggested output 552C may include one or more embedded timestamps, similar to the embedded timestamps of FIG. 5B. As such, in some examples, machine learning module 510 may identify, based on the video information and the user intent to receive a summary of the video, one or more timestamps that correspond to “key” points or portions of the video. In some examples, machine learning module 510 may determine “key” timestamps and/or video segments based on relevance to the video title, a prompt, and/or machine learning techniques for summarization.

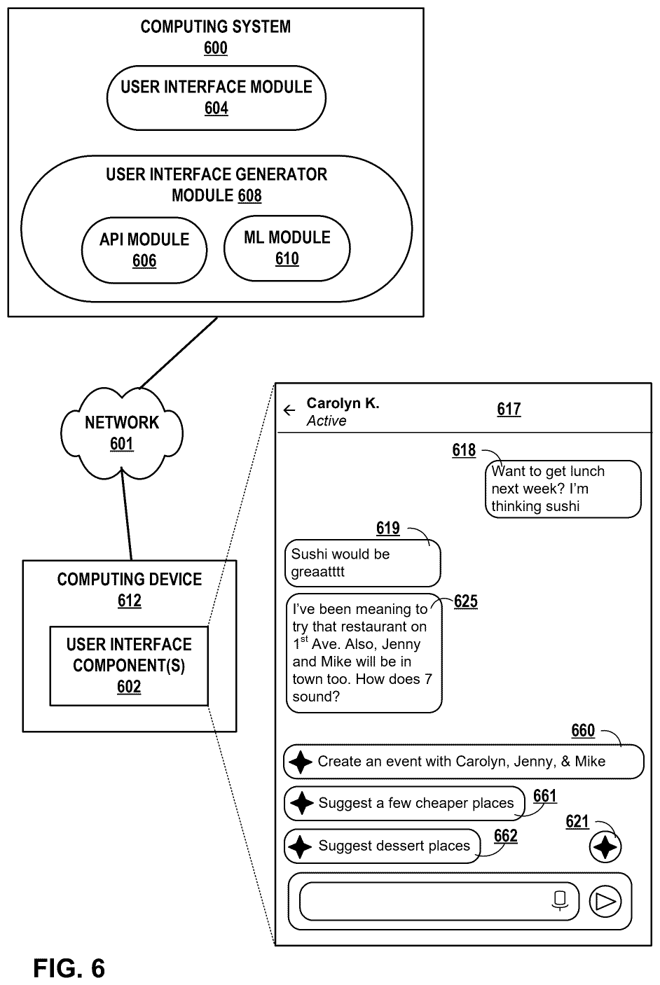

FIG. 6 is a conceptual diagram illustrating another example computing system for sending suggested output and corresponding graphical components based on at least one prompt, in accordance with one or more techniques of this disclosure. In some examples, the graphical components included in a current GUI may include a subset of graphical components associated with at least the portion of the content. For example, text messages 618, 619, and 625 may each be associated with at least the portion of the content included in messaging application GUI 617. In some examples, the at least one suggested output includes at least one associated application, text, at least one image, at least one link, or the prompt itself (e.g., as a suggested action). As shown in the example of FIG. 6, computing system 600 may determine, based on the content of text messages 618, 619, and 625, respectively, suggested output 660, “Create an event with Carolyn, Jenny, & Mike,” (which may be a suggested action corresponding to a calendar application), suggested output 661, “Suggest a few cheaper places” (which may be a suggested action corresponding to predetermined text or other suggested output determined by computing system 600), and suggested output 662, “Suggest dessert places” (which may be another suggested action corresponding to predetermined text or other suggested output determined by computing system 600). As such, computing system 600 may generate instructions for dynamically generating graphical components associated with the at least one suggested output (e.g., widgets for suggested actions 660, 661, and 662). In some examples, computing system 600 may receive an indication of an input detected at a location of an input device 602 that corresponds to at least one graphical component from the second plurality of graphical components, e.g., a widget corresponding to suggested action 660, 661, or 662. Computing system 600 may then generate, based on a respective suggested output from the one or more suggested outputs associated with the at least one graphical component, instructions for generating at least one GUI associated with the respective suggested output, instructions for prepopulating at least one text entry field with the at least one suggested output, and/or instructions for executing one or more functions associated with the respective suggested output.

In the example of FIG. 6, a user may select suggested output 660, in which computing system 600 may then generate instructions for executing one or more functions associated with the calendar application that can create a calendar event with Carolyn, Jenny, and Mike (which may be based on the content of text message 625). As another example, a user may select suggested out 661, in which computing system 600 may then generate instructions for prepopulating at least one text entry field (e.g., a text entry field included in messaging application GUI 617) with the at least one suggested output, such as local restaurants determined by computing system 600 to be cheaper alternatives to the restaurant referred to in text message 625 (e.g., based on other data retrieved by computing system 600, such as user location data, and/or data sourced from other applications, such as a web browser application). As such, in general, computing system 600 may infer and/or determine, based on the content included in GUI 617, and by applying machine learning module 610, at least one prompt, e.g., implicit prompts such as, “Create a calendar event with Carolyn, Jenny, and Mike,” “Suggest a few cheaper places,” and “Suggest dessert places,” which may then be provided as suggested output (e.g., suggested actions) that a user can select. As such, computing system 600 may provide users a “shortcut” to specific actions, which may be determined using the machine learning methods described herein.

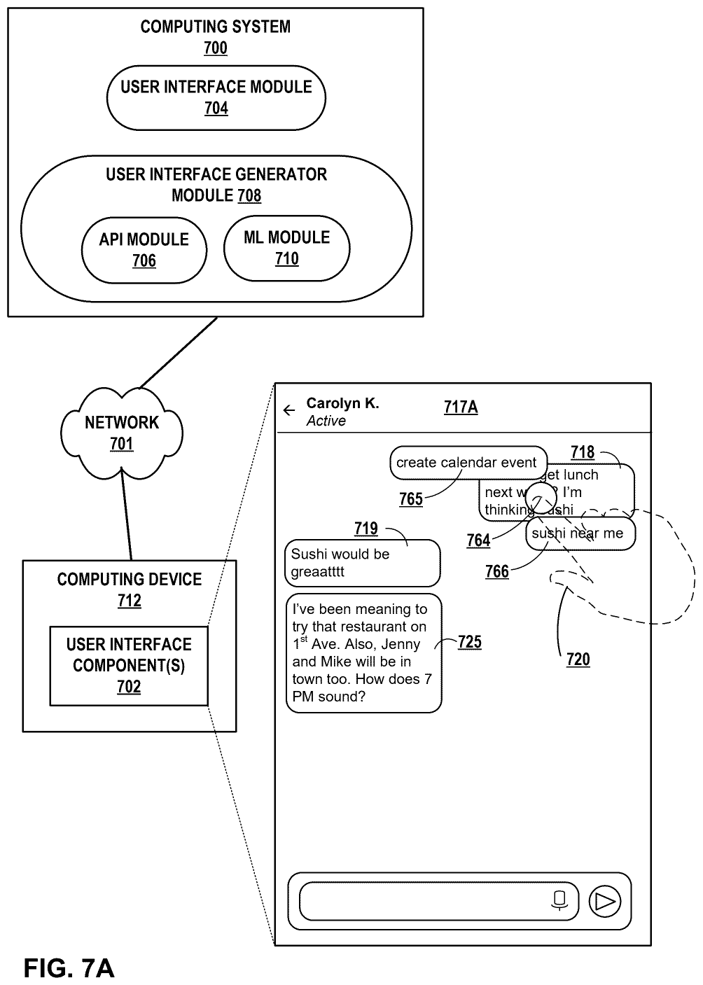

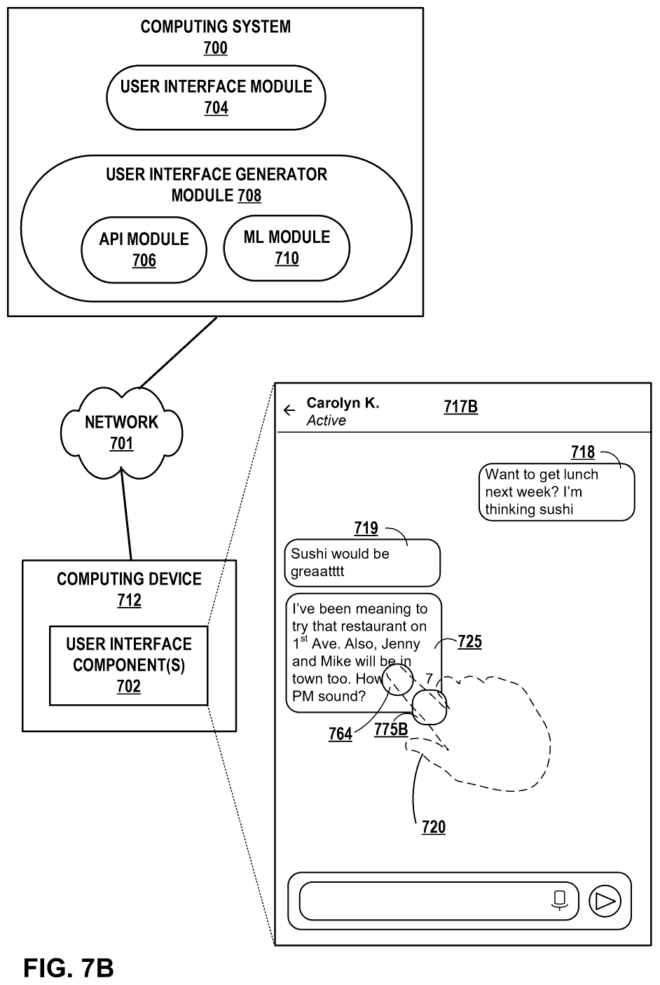

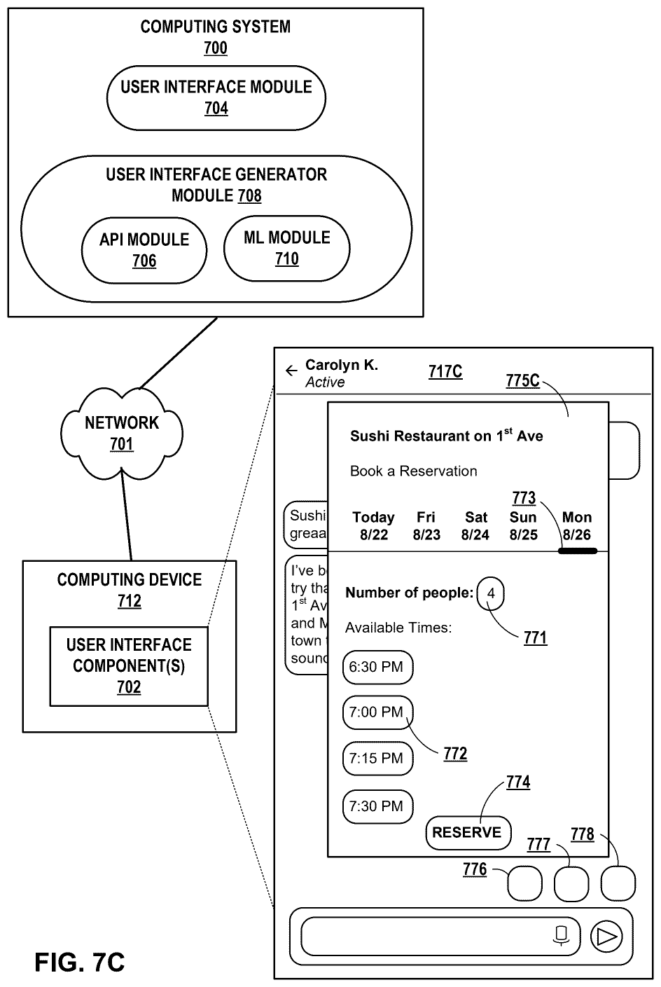

FIG. 7A is a conceptual diagram illustrating another example computing system for sending suggested output and corresponding graphical components based on at least one prompt, in accordance with one or more techniques of this disclosure. In the example of FIG. 7A, computing system 700 may receive at least one additional indication of at least one additional input detected at at least one location of an input device 702 that corresponds to one or more graphical components from a subset of graphical components. For example, user 720 may interact with draggable circle 764 and “drag” or “hover” draggable circle 764 over one or more of text messages 718, 719, and 725. As shown in the example of FIG. 7A, in some examples, each graphical component from the second plurality of graphical components may correspond to a respective graphical component from the subset of graphical components. That is, graphical component 765, which may be associated with suggested output such as, “create calendar event,” and graphical component 766, which may be associated with suggested output such as, “sushi near me,” may correspond to text message 718. As shown in the example of FIG. 7A, a positioning of each graphical component from the second plurality of graphical components may be based on a positioning of the respective graphical component from the subset of graphical components. In some examples, the instructions for generating the second plurality of graphical components further include instructions for generating each graphical component from the second plurality of graphical components based on the at least one additional indication of the least one additional input detected at the at least one location of the input device that corresponds to the respective graphical component from the subset of graphical components. That is, when user 720 hovers draggable circle 764 over text message 718, graphical components 765 and 766 may be dynamically rendered and overlay text message 718. When user 720 no longer hovers draggable circle 764 over text message 718, graphical components 765 and 766 may “disappear.”

FIG. 7B is another example of the computing system of FIG. 7A for sending suggested output and corresponding graphical components based on at least one prompt, in accordance with one or more techniques of this disclosure. In the example of FIG. 7B, user 720 may hover draggable circle 764 over text message 725, in which associated application widget 775B may be dynamically rendered as an overlay of text message 725. That is, as described herein, computing system 700 may generate one or more suggested outputs that include, for example, at least one associated application. As such, in the example of FIG. 7B, application widget 775B may be a widget for an application determined by computing system 700 to be associated with the content included in text message 725, and/or at least one prompt determined based on text message 725, such as “Book reservation at restaurant on 1st Ave for 4 people at 7 PM.”

FIG. 7C is another example of the computing system of FIG. 7A for sending suggested output and corresponding graphical components based on at least one prompt, in accordance with one or more techniques of this disclosure. In the example of FIG. 7C, user 720 may interact with an associated application widget to have computing system 700 further generate instructions for generating, for example, at least one GUI associated with the respective suggested output, e.g., one or more suggested actions or outputs corresponding to a suggested application. As shown in the example of FIG. 7C, a user may interact with an associated application widget to have widget 775C be displayed, which may be a widget for the associated application that includes at least one text entry field prepopulated with the at least one suggested output. As shown in the example of FIG. 7C, the suggested output may be shown as prepopulated text entry field 771 (e.g., “4” for 4 people), selected date 773 (e.g., “Mon 8/26”), and selected time 772 (e.g., “7:00 PM”), in which the selected output may be determined by computing system 700 based on the content included in messaging application GUI 717C. As shown, widget 775C may further include “reserve” button 774, which a user may interact with to complete the task of booking the suggested reservation through the suggested restaurant reservations application. In some examples, computing system 700 may further generate instructions for generating, at least one GUI or widget associated with other associated applications, such as widgets 776, 777, and 778, which a user may interact with to toggle to different GUIs that correspond to each associated application.

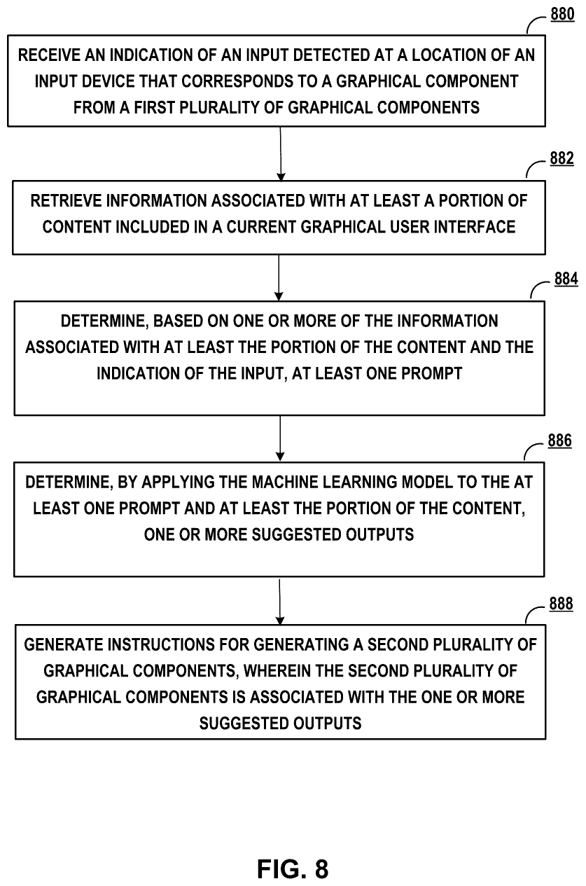

FIG. 8 is a flowchart illustrating an example operation for sending suggested output and corresponding graphical components based on at least one prompt, in accordance with one or more techniques of this disclosure. The example of FIG. 8 is described with respect to FIGS. 1-7C. Computing system 100 receives an indication of an input detected at a location of user interface component 102 that corresponds to one or more of graphical components 105, 107, 221, or 764 (880). Computing system 100 retrieves information associated with at least a portion of content included in a current graphical user interface, such as GUI 103 or GUI 217 (882). In some examples, computing system 100 retrieves the information associated with at least the portion of the content responsive to receiving the indication of the input. Computing system 100 determines, based on one or more of the information associated with at least the portion of the content and the indication of the input, at least one prompt, such as an explicit prompt “Where can I buy the pillows in this video?” based on natural language input 116, or an implicit prompt “Book reservation at the restaurant on 1st Ave for 4 people at 7 PM” based on text message 725 (884). In examples in which the input is a natural language input, such as input 116, computing system 100 determines the at least one prompt associated with at least the portion of the content by applying speech-to-text module 226 to the indication of the natural language user input. In some examples, computing system 100 determines the one or more suggested outputs by applying machine learning module 310 to the at least one prompt and at least the portion of the content. Computing system 100 determines, by applying machine learning module 310 (which may include a large language model) to the at least one prompt and at least the portion of the content, one or more suggested outputs, such as suggested outputs 552A. (886). In some examples, the one or more suggested outputs include one or more of at least one associated application (e.g., the applications corresponding to widgets 775B, 775C, 776, 777, and 778), the at least one prompt (e.g., suggested action widgets 660, 661, and 662), text (e.g., suggested output 552A), at least one image, and at least one link (e.g., embedded link 553).

Computing system 100 generates instructions for generating a second plurality of graphical components, in which the second plurality of graphical components is associated with the one or more suggested outputs (e.g., widget 509 is associated with suggested output 552A) (888).

In some examples, computing system 100 generates the instructions for generating the second plurality of graphical components, in which the second plurality of graphical components is associated with the one or more suggested outputs, and the instructions further include instructions for transitioning from the first plurality of graphical components to the second plurality of graphical components. In some examples, the first plurality of graphical components includes at least one graphical component in a collapsed state, and the second plurality of graphical components includes at least one graphical component in an expanded state. In these examples, the instructions for transitioning from the first plurality of graphical components to the second plurality of graphical components further include instructions for transitioning from the at least one graphical component in the collapsed state to the at least one graphical component in the expanded state (e.g., transitioning from widget 109B to widget 509). In some examples, the instructions for transitioning from the at least one graphical component in the collapsed state (e.g., widget 109B) to the at least one graphical component in the expanded state (e.g., widget 509) are based on an amount of data included in the one or more suggested outputs (e.g., suggested output 552A).

In some examples, computing system 100 determines the at least one prompt based on the information associated with at least the portion of the content by applying machine learning module 310 to the information associated with at least the portion of the content. In some examples, the first plurality of graphical components includes a subset of graphical components associated with at least the portion of the content, such as text messages 718, 719, and 725. In these examples, computing system 100 receives at least one additional indication of at least one additional input detected at at least one location of an input device that corresponds to one or more graphical components from the subset of graphical components, e.g., user 720 may hover draggable circle 764 over one or more of text messages 718, 719, and 725. In these examples, each graphical component from the second plurality of graphical components may correspond to a respective graphical component from the subset of graphical components. For example, graphical components 765 and 766 may correspond to text message 718, and graphical component 775B may correspond to text message 725. Furthermore, in some examples, a positioning of each graphical component from the second plurality of graphical components is based on a positioning of the respective graphical component from the subset of graphical components. In some examples, the instructions for generating the second plurality of graphical components further include instructions for generating each graphical component from the second plurality of graphical components based on the at least one additional indication of the least one additional input detected at the at least one location of the input device that corresponds to the respective graphical component from the subset of graphical components. For example, graphical components 765, 766, and 775B may be dynamically rendered when user 710 hovers draggable circle 764 over a corresponding text message.

In some examples, computing system 100 may receive an indication of an input detected at a location of an input device that corresponds to at least one graphical component from the second plurality of graphical components, and generate, based on a respective suggested output from the one or more suggested outputs associated with the at least one graphical component, instructions for one or more of generating at least one graphical user interface associated with the respective suggested output, prepopulating at least one text entry field with the at least one suggested output, and executing one or more functions associated with the respective suggested output.

In one or more examples, the functions described may be implemented in hardware, software, firmware, or any combination thereof. If implemented in software, the functions may be stored on or transmitted over, as one or more instructions or code, a computer-readable medium and executed by a hardware-based processing unit. Computer-readable media may include computer-readable storage media, which corresponds to a tangible medium such as data storage media, or communication media including any medium that facilitates transfer of a computer program from one place to another, e.g., according to a communication protocol. In this manner, computer-readable media generally may correspond to (1) tangible computer-readable storage media, which is non-transitory or (2) a communication medium such as a signal or carrier wave. Data storage media may be any available media that may be accessed by one or more computers or one or more processors to retrieve instructions, code and/or data structures for implementation of the techniques described in this disclosure. A computer program product may include a computer-readable medium.

By way of example, and not limitation, such computer-readable storage media may comprise RAM, ROM, EEPROM, CD-ROM or other optical disk storage, magnetic disk storage, or other magnetic storage devices, flash memory, or any other storage medium that may be used to store desired program code in the form of instructions or data structures and that may be accessed by a computer. Also, any connection is properly termed a computer-readable medium. For example, if instructions are transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. It should be understood, however, that computer-readable storage media and data storage media do not include connections, carrier waves, signals, or other transient media, but are instead directed to non-transient, tangible storage media. Disk and disc, as used herein, includes compact disc (CD), laser disc, optical disc, digital versatile disc (DVD), and Blu-ray disc, where disks usually reproduce data magnetically, while discs reproduce data optically with lasers. Combinations of the above should also be included within the scope of computer-readable media.

Instructions may be executed by one or more processors, such as one or more digital signal processors (DSPs), general purpose microprocessors, application specific integrated circuits (ASICs), field programmable logic arrays (FPGAs), or other equivalent integrated or discrete logic circuitry. Accordingly, the term “processor,” as used herein may refer to any of the foregoing structures or any other structure suitable for implementation of the techniques described herein. In addition, in some aspects, the functionality described herein may be provided within dedicated hardware and/or software modules. Also, the techniques could be fully implemented in one or more circuits or logic elements.

The techniques of this disclosure may be implemented in a wide variety of devices or apparatuses, including a wireless handset, an integrated circuit (IC) or a set of ICs (e.g., a chip set). Various components, modules, or units are described in this disclosure to emphasize functional aspects of devices configured to perform the disclosed techniques, but do not necessarily require realization by different hardware units. Rather, various units may be combined in a hardware unit or provided by a collection of intraoperative hardware units, including one or more processors, in conjunction with suitable software and/or firmware.

It is to be recognized that, depending on the example, certain acts or events of any of the techniques described herein may be performed in a different sequence, may be added, merged, or left out altogether (e.g., not all described acts or events are necessary for the practice of the techniques). Moreover, in certain examples, acts or events may be performed concurrently, e.g., through multi-threaded processing, interrupt processing, or multiple processors, rather than sequentially.

In some examples, a computer-readable storage medium comprises a non-transitory medium. The term “non-transitory” indicates that the storage medium is not embodied in a carrier wave or a propagated signal. In certain examples, a non-transitory storage medium may store data that can, over time, change (e.g., in RAM or cache).

In one or more examples, the functions described may be implemented in hardware, software, firmware, or any combination thereof. If implemented in software, the functions may be stored on or transmitted over, as one or more instructions or code, a computer-readable medium and executed by a hardware-based processing unit. Computer-readable media may include computer-readable storage media, which corresponds to a tangible medium such as data storage media, or communication media including any medium that facilitates transfer of a computer program from one place to another, e.g., according to a communication protocol. In this manner, computer-readable media generally may correspond to (1) tangible computer-readable storage media, which is non-transitory or (2) a communication medium such as a signal or carrier wave. Data storage media may be any available media that may be accessed by one or more computers or one or more processors to retrieve instructions, code and/or data structures for implementation of the techniques described in this disclosure. A computer program product may include a computer-readable medium.

By way of example, and not limitation, such computer-readable storage media may comprise RAM, ROM, EEPROM, CD-ROM or other optical disk storage, magnetic disk storage, or other magnetic storage devices, flash memory, or any other storage medium that may be used to store desired program code in the form of instructions or data structures and that may be accessed by a computer. Also, any connection is properly termed a computer-readable medium. For example, if instructions are transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. It should be understood, however, that computer-readable storage media and data storage media do not include connections, carrier waves, signals, or other transient media, but are instead directed to non-transient, tangible storage media. Disk and disc, as used herein, includes compact disc (CD), laser disc, optical disc, digital versatile disc (DVD), and Blu-ray disc, where disks usually reproduce data magnetically, while discs reproduce data optically with lasers. Combinations of the above should also be included within the scope of computer-readable media.

Instructions may be executed by one or more processors, such as one or more digital signal processors (DSPs), general purpose microprocessors, application specific integrated circuits (ASICs), field programmable logic arrays (FPGAs), or other equivalent integrated or discrete logic circuitry. Accordingly, the term “processor,” as used herein may refer to any of the foregoing structures or any other structure suitable for implementation of the techniques described herein. In addition, in some aspects, the functionality described herein may be provided within dedicated hardware and/or software modules. Also, the techniques could be fully implemented in one or more circuits or logic elements.

The techniques of this disclosure may be implemented in a wide variety of devices or apparatuses, including a wireless handset, an integrated circuit (IC) or a set of ICs (e.g., a chip set). Various components, modules, or units are described in this disclosure to emphasize functional aspects of devices configured to perform the disclosed techniques, but do not necessarily require realization by different hardware units. Rather, various units may be combined in a hardware unit or provided by a collection of intraoperative hardware units, including one or more processors, in conjunction with suitable software and/or firmware.

It is to be recognized that, depending on the example, certain acts or events of any of the techniques described herein may be performed in a different sequence, may be added, merged, or left out altogether (e.g., not all described acts or events are necessary for the practice of the techniques). Moreover, in certain examples, acts or events may be performed concurrently, e.g., through multi-threaded processing, interrupt processing, or multiple processors, rather than sequentially.

In some examples, a computer-readable storage medium comprises a non-transitory medium. The term “non-transitory” indicates that the storage medium is not embodied in a carrier wave or a propagated signal. In certain examples, a non-transitory storage medium may store data that can, over time, change (e.g., in RAM or cache).

Example 1: A method includes receiving, by a computing system, an indication of an input detected at a location of an input device that corresponds to a graphical component from a first plurality of graphical components; retrieving, by the computing system, information associated with at least a portion of content included in a current graphical user interface; determining, by the computing system, and based on one or more of the information associated with at least the portion of the content and the indication of the input, at least one prompt; determining, by the computing system, and by applying the machine learning model to the at least one prompt and at least the portion of the content, one or more suggested outputs; and generating, by the computing system, instructions for generating a second plurality of graphical components, wherein the second plurality of graphical components is associated with the one or more suggested outputs.

Example 2: The method of example 1, wherein the one or more suggested outputs include one or more of at least one associated application, the at least one prompt, text, at least one image, and at least one link.

Example 3: The method of any of examples 1 and 2, wherein retrieving the information associated with at least the portion of the content is responsive to receiving the indication of the input.

Example 4: The method of example 3, wherein the input is a natural language input includes determining, by the computing system, the at least one prompt associated with at least the portion of the content by applying a speech-to-text algorithm to the indication of the natural language user input; determining, by the computing system, and by applying the machine learning model to the at least one prompt and at least the portion of the content, the one or more suggested outputs; and generating, by the computing system, the instructions for generating the second plurality of graphical components, wherein the second plurality of graphical components is associated with the one or more suggested outputs, and wherein the instructions further include instructions for transitioning from the first plurality of graphical components to the second plurality of graphical components.

Example 5: The method of example 4, wherein the first plurality of graphical components includes at least one graphical component in a collapsed state, wherein the second plurality of graphical components includes at least one graphical component in an expanded state, and wherein the instructions for transitioning from the first plurality of graphical components to the second plurality of graphical components further include instructions for transitioning from the at least one graphical component in the collapsed state to the at least one graphical component in the expanded state.

Example 6: The method of example 5, wherein the instructions for transitioning from the at least one graphical component in the collapsed state to the at least one graphical component in the expanded state are based on an amount of data included in the one or more suggested outputs.

Example 7: The method of any of examples 1 through 6, wherein determining the at least one prompt is based on the information associated with at least the portion of the content, the method further includes applying, by the computing system, the machine learning model to the information associated with at least the portion of the content to determine the at least one prompt.

Example 8: The method of example 7, wherein the first plurality of graphical components includes a subset of graphical components associated with at least the portion of the content, the method further includes receiving, by the computing system, at least one additional indication of at least one additional input detected at at least one location of the input device that corresponds to one or more graphical components from the subset of graphical components, wherein each graphical component from the second plurality of graphical components corresponds to a respective graphical component from the subset of graphical components, and wherein a positioning of each graphical component from the second plurality of graphical components is based on a positioning of the respective graphical component from the subset of graphical components.

Example 9: The method of example 8, wherein the instructions for generating the second plurality of graphical components further include instructions for generating each graphical component from the second plurality of graphical components based on the at least one additional indication of the least one additional input detected at the at least one location of the input device that corresponds to the respective graphical component from the subset of graphical components.

Example 10: The method of any of examples 1 through 9, further includes receiving, by the computing system, an indication of an input detected at a location of an input device that corresponds to at least one graphical component from the second plurality of graphical components; and generating, by the computing system, and based on a respective suggested output from the one or more suggested outputs associated with the at least one graphical component, instructions for one or more of: generating at least one graphical user interface associated with the respective suggested output, prepopulating at least one text entry field with the at least one suggested output, and executing one or more functions associated with the respective suggested output.

Example 11: The method of any of examples 1 through 10, wherein the machine learning model is a language model.

Example 12: A computing system includes one or more processors; and one or more storage devices that store instructions, wherein the instructions, when executed by the one or more processors, cause the one or more processors to: receive an indication of an input detected at a location of an input device that corresponds to a graphical component from a first plurality of graphical components; retrieve information associated with at least a portion of content included in a current graphical user interface; determine, based on one or more of the information associated with at least the portion of the content and the indication of the input, at least one prompt; determine, by applying the machine learning model to the at least one prompt and at least the portion of the content, one or more suggested outputs; and generate instructions for generating a second plurality of graphical components, wherein the second plurality of graphical components is associated with the one or more suggested outputs.

Example 13: The computing system of example 12, wherein the one or more suggested outputs include one or more of at least one associated application, the at least one prompt, text, at least one image, and at least one link.

Example 14: The computing system of any of examples 12 and 13, wherein retrieving the information associated with at least the portion of the content is responsive to receiving the indication of the input.

Example 15: The computing system of example 14, wherein the input is a natural language input, wherein the instructions further cause the one or more processors to: determine the at least one prompt associated with at least the portion of the content by applying a speech-to-text algorithm to the indication of the natural language user input; determine, by applying the machine learning model to the at least one prompt and at least the portion of the content, the one or more suggested outputs; and generate the instructions for generating the second plurality of graphical components, wherein the second plurality of graphical components is associated with the one or more suggested outputs, and wherein the instructions further include instructions for transitioning from the first plurality of graphical components to the second plurality of graphical components.

Example 16: The computing system of example 15, wherein the first plurality of graphical components includes at least one graphical component in a collapsed state, wherein the second plurality of graphical components includes at least one graphical component in an expanded state, and wherein the instructions for transitioning from the first plurality of graphical components to the second plurality of graphical components further include instructions for transitioning from the at least one graphical component in the collapsed state to the at least one graphical component in the expanded state.

Example 17: The computing system of example 16, wherein the instructions for transitioning from the at least one graphical component in the collapsed state to the at least one graphical component in the expanded state are based on an amount of data included in the one or more suggested outputs.

Example 18: The computing system of any of examples 12 through 17, wherein determining the at least one prompt is based on the information associated with at least the portion of the content, wherein the instructions further cause the one or more processors to: apply the machine learning model to the information associated with at least the portion of the content to determine the at least one prompt.

Example 19: The computing system of example 18, wherein the first plurality of graphical components includes a subset of graphical components associated with at least the portion of the content, wherein the instructions further cause the one or more processors to: receive at least one additional indication of at least one additional input detected at at least one location of the input device that corresponds to one or more graphical components from the subset of graphical components, wherein each graphical component from the second plurality of graphical components corresponds to a respective graphical component from the subset of graphical components, and wherein a positioning of each graphical component from the second plurality of graphical components is based on a positioning of the respective graphical component from the subset of graphical components.

Example 20: The computing system of example 19, wherein the instructions for generating the second plurality of graphical components further include instructions for generating each graphical component from the second plurality of graphical components based on the at least one additional indication of the least one additional input detected at the at least one location of the input device that corresponds to the respective graphical component from the subset of graphical components.

Example 21: The computing system of any of examples 12 through 20, wherein the instructions further cause the one or more processors to: receive an indication of an input detected at a location of an input device that corresponds to at least one graphical component from the second plurality of graphical components; and generate, based on a respective suggested output from the one or more suggested outputs associated with the at least one graphical component, instructions for one or more of: generating at least one graphical user interface associated with the respective suggested output, prepopulating at least one text entry field with the at least one suggested output, and executing one or more functions associated with the respective suggested output.

Example 22: The computing system of any of examples 12 through 21, wherein the machine learning model is a language model.

Example 23: A non-transitory computer-readable storage medium encoded with instructions that, when executed by one or more processors, cause one or more processors to: receive an indication of an input detected at a location of an input device that corresponds to a graphical component from a first plurality of graphical components; retrieve information associated with at least a portion of content included in a current graphical user interface; determine, based on one or more of the information associated with at least the portion of the content and the indication of the input, at least one prompt; determine, by applying the machine learning model to the at least one prompt and at least the portion of the content, one or more suggested outputs; and generate instructions for generating a second plurality of graphical components, wherein the second plurality of graphical components is associated with the one or more suggested outputs.

Example 24: The non-transitory computer-readable storage medium of example 23, wherein the one or more suggested outputs include one or more of at least one associated application, the at least one prompt, text, at least one image, and at least one link.

Example 25: The non-transitory computer-readable storage medium of any of examples 23 and 24, wherein retrieving the information associated with at least the portion of the content is responsive to receiving the indication of the input.

Example 26: The non-transitory computer-readable storage medium of example 25, wherein the input is a natural language input, wherein the instructions further cause the one or more processors to: determine the at least one prompt associated with at least the portion of the content by applying a speech-to-text algorithm to the indication of the natural language user input; determine, by applying the machine learning model to the at least one prompt and at least the portion of the content, the one or more suggested outputs; and generate the instructions for generating the second plurality of graphical components, wherein the second plurality of graphical components is associated with the one or more suggested outputs, and wherein the instructions further include instructions for transitioning from the first plurality of graphical components to the second plurality of graphical components.

Example 27: The non-transitory computer-readable storage medium of example 26, wherein the first plurality of graphical components includes at least one graphical component in a collapsed state, wherein the second plurality of graphical components includes at least one graphical component in an expanded state, and wherein the instructions for transitioning from the first plurality of graphical components to the second plurality of graphical components further include instructions for transitioning from the at least one graphical component in the collapsed state to the at least one graphical component in the expanded state.

Example 28: The non-transitory computer-readable storage medium of example 27, wherein the instructions for transitioning from the at least one graphical component in the collapsed state to the at least one graphical component in the expanded state are based on an amount of data included in the one or more suggested outputs.

Example 29: The non-transitory computer-readable storage medium of any of examples 23 through 28, wherein to determine the at least one prompt is based on the information associated with at least the portion of the content, the instructions further cause the one or more processors to apply the machine learning model to the information associated with at least the portion of the content to determine the at least one prompt.

Example 30: The non-transitory computer-readable storage medium of example 29, wherein the first plurality of graphical components includes a subset of graphical components associated with at least the portion of the content, wherein the instructions further cause the one or more processors to: receive at least one additional indication of at least one additional input detected at at least one location of the input device that corresponds to one or more graphical components from the subset of graphical components, wherein each graphical component from the second plurality of graphical components corresponds to a respective graphical component from the subset of graphical components, and wherein a positioning of each graphical component from the second plurality of graphical components is based on a positioning of the respective graphical component from the subset of graphical components.

Example 31: The non-transitory computer-readable storage medium of example 30, wherein the instructions for generating the second plurality of graphical components further include instructions for generating each graphical component from the second plurality of graphical components based on the at least one additional indication of the least one additional input detected at the at least one location of the input device that corresponds to the respective graphical component from the subset of graphical components.

Example 32: The non-transitory computer-readable storage medium of any of examples 23 through 31, wherein the instructions further cause the one or more processors to: receive an indication of an input detected at a location of an input device that corresponds to at least one graphical component from the second plurality of graphical components; and generate, based on a respective suggested output from the one or more suggested outputs associated with the at least one graphical component, instructions for one or more of: generating at least one graphical user interface associated with the respective suggested output, prepopulating at least one text entry field with the at least one suggested output, and executing one or more functions associated with the respective suggested output.

Example 33: The non-transitory computer-readable storage medium of any of examples 23 through 32, wherein the machine learning model is a language model.

Example 34: A computer program product for generating graphical components that correspond to suggested output, the computer program product comprising one or more instructions that, when executed by at least one processor, cause the at least one processor to: receive an indication of an input detected at a location of an input device that corresponds to a graphical component from a first plurality of graphical components; retrieve information associated with at least a portion of content included in a current graphical user interface; determine, based on one or more of the information associated with at least the portion of the content and the indication of the input, at least one prompt; determine, by applying the machine learning model to the at least one prompt and at least the portion of the content, one or more suggested outputs; and generate instructions for generating a second plurality of graphical components, wherein the second plurality of graphical components is associated with the one or more suggested outputs.

Various examples have been described. These and other examples are within the scope of the following claims.

What is claimed is:

1. A method comprising:
receiving, by a computing system, an indication of an input detected at a location of an input device that corresponds to a graphical component from a first plurality of graphical components;
retrieving, by the computing system, information associated with at least a portion of content included in a current graphical user interface;
determining, by the computing system, and based on one or more of the information associated with at least the portion of the content and the indication of the input, at least one prompt;
determining, by the computing system, and by applying a machine learning model to the at least one prompt and at least the portion of the content, one or more suggested outputs; and
generating, by the computing system, instructions for generating a second plurality of graphical components, wherein the second plurality of graphical components is associated with the one or more suggested outputs.

2. The method of claim 1, wherein the one or more suggested outputs include one or more of at least one associated application, the at least one prompt, text, at least one image, and at least one link.

3. The method of claim 1, wherein retrieving the information associated with at least the portion of the content is responsive to receiving the indication of the input.

4. The method of claim 3, wherein the input is a natural language input, the method further comprising:
determining, by the computing system, the at least one prompt associated with at least the portion of the content by applying a speech-to-text algorithm to the indication of the natural language input;
determining, by the computing system, and by applying the machine learning model to the at least one prompt and at least the portion of the content, the one or more suggested outputs; and
generating, by the computing system, the instructions for generating the second plurality of graphical components, wherein the second plurality of graphical components is associated with the one or more suggested outputs, and wherein the instructions further include instructions for transitioning from the first plurality of graphical components to the second plurality of graphical components.

5. The method of claim 4, wherein the first plurality of graphical components includes at least one graphical component in a collapsed state, wherein the second plurality of graphical components includes at least one graphical component in an expanded state, and wherein the instructions for transitioning from the first plurality of graphical components to the second plurality of graphical components further include instructions for transitioning from the at least one graphical component in the collapsed state to the at least one graphical component in the expanded state.

6. The method of claim 5, wherein the instructions for transitioning from the at least one graphical component in the collapsed state to the at least one graphical component in the expanded state are based on an amount of data included in the one or more suggested outputs.

7. The method of claim 1, wherein determining the at least one prompt is based on the information associated with at least the portion of the content, the method further comprising:
applying, by the computing system, the machine learning model to the information associated with at least the portion of the content to determine the at least one prompt.

8. The method of claim 7, wherein the first plurality of graphical components includes a subset of graphical components associated with at least the portion of the content, the method further comprising:
receiving, by the computing system, at least one additional indication of at least one additional input detected at at least one location of the input device that corresponds to one or more graphical components from the subset of graphical components,
wherein each graphical component from the second plurality of graphical components corresponds to a respective graphical component from the subset of graphical components, and
wherein a positioning of each graphical component from the second plurality of graphical components is based on a positioning of the respective graphical component from the subset of graphical components.

9. The method of claim 8, wherein the instructions for generating the second plurality of graphical components further include instructions for generating each graphical component from the second plurality of graphical components based on the at least one additional indication of the least one additional input detected at the at least one location of the input device that corresponds to the respective graphical component from the subset of graphical components.

10. The method of claim 1, further comprising:
receiving, by the computing system, an indication of an input detected at a location of an input device that corresponds to at least one graphical component from the second plurality of graphical components; and
generating, by the computing system, and based on a respective suggested output from the one or more suggested outputs associated with the at least one graphical component, instructions for one or more of:
generating at least one graphical user interface associated with the respective suggested output,
prepopulating at least one text entry field with the at least one suggested output, and
executing one or more functions associated with the respective suggested output.

11. A computing system comprising:
one or more processors; and
one or more storage devices that store instructions, wherein the instructions, when executed by the one or more processors, cause the one or more processors to:
receive an indication of an input detected at a location of an input device that corresponds to a graphical component from a first plurality of graphical components;
retrieve information associated with at least a portion of content included in a current graphical user interface;
determine, based on one or more of the information associated with at least the portion of the content and the indication of the input, at least one prompt;
determine, by applying a machine learning model to the at least one prompt and at least the portion of the content, one or more suggested outputs; and
generate instructions for generating a second plurality of graphical components, wherein the second plurality of graphical components is associated with the one or more suggested outputs.

12. The computing system of claim 11, wherein the one or more suggested outputs include one or more of at least one associated application, the at least one prompt, text, at least one image, and at least one link.

13. The computing system of claim 11, wherein the input is a natural language input, wherein the instructions further cause the one or more processors to:
determine the at least one prompt associated with at least the portion of the content by applying a speech-to-text algorithm to the indication of the natural language input;
determine, by applying the machine learning model to the at least one prompt and at least the portion of the content, the one or more suggested outputs; and
generate the instructions for generating the second plurality of graphical components, wherein the second plurality of graphical components is associated with the one or more suggested outputs, and wherein the instructions further include instructions for transitioning from the first plurality of graphical components to the second plurality of graphical components.

14. The computing system of claim 13, wherein the first plurality of graphical components includes at least one graphical component in a collapsed state, wherein the second plurality of graphical components includes at least one graphical component in an expanded state, and wherein the instructions for transitioning from the first plurality of graphical components to the second plurality of graphical components further include instructions for transitioning from the at least one graphical component in the collapsed state to the at least one graphical component in the expanded state.

15. The computing system of claim 14, wherein the instructions for transitioning from the at least one graphical component in the collapsed state to the at least one graphical component in the expanded state are based on an amount of data included in the one or more suggested outputs.

16. The computing system of claim 11, wherein determining the at least one prompt is based on the information associated with at least the portion of the content, wherein the instructions further cause the one or more processors to:
apply the machine learning model to the information associated with at least the portion of the content to determine the at least one prompt.

17. The computing system of claim 16, wherein the first plurality of graphical components includes a subset of graphical components associated with at least the portion of the content, wherein the instructions further cause the one or more processors to:
receive at least one additional indication of at least one additional input detected at at least one location of the input device that corresponds to one or more graphical components from the subset of graphical components,
wherein each graphical component from the second plurality of graphical components corresponds to a respective graphical component from the subset of graphical components, and
wherein a positioning of each graphical component from the second plurality of graphical components is based on a positioning of the respective graphical component from the subset of graphical components.

18. The computing system of claim 17, wherein the instructions for generating the second plurality of graphical components further include instructions for generating each graphical component from the second plurality of graphical components based on the at least one additional indication of the least one additional input detected at the at least one location of the input device that corresponds to the respective graphical component from the subset of graphical components.

19. The computing system of claim 11, wherein the instructions further cause the one or more processors to:
receive an indication of an input detected at a location of an input device that corresponds to at least one graphical component from the second plurality of graphical components; and
generate, based on a respective suggested output from the one or more suggested outputs associated with the at least one graphical component, instructions for one or more of:
generating at least one graphical user interface associated with the respective suggested output,
prepopulating at least one text entry field with the at least one suggested output, and
executing one or more functions associated with the respective suggested output.

20. A non-transitory computer-readable storage medium encoded with instructions that, when executed by one or more processors, cause one or more processors to:
receive an indication of an input detected at a location of an input device that corresponds to a graphical component from a first plurality of graphical components;
retrieve information associated with at least a portion of content included in a current graphical user interface;
determine, based on one or more of the information associated with at least the portion of the content and the indication of the input, at least one prompt;
determine, by applying a machine learning model to the at least one prompt and at least the portion of the content, one or more suggested outputs; and
generate instructions for generating a second plurality of graphical components, wherein the second plurality of graphical components is associated with the one or more suggested outputs.
